(19) United States
(12) Patent Application Publication
(10) Pub. No.: US 2020/0205224 A1
(43) Pub. Date: Jun. 25, 2020

(54) METHOD AND DEVICE FOR RECEIVING DATA UNIT

(71) Applicant: LG ELECTRONICS INC., Seoul (KR)

(72) Inventors: Gyeongcheol LEE, Seoul (KR); Seungjune YI, Seoul (KR)

(73) Assignee: LG ELECTRONICS INC., Seoul (KR)

(21) Appl. No.: 16/608,169

(22) PCT Filed: Apr. 27, 2018
(86) PCT No.: PCT/KR2018/004930

§ 371 Date: Oct. 24, 2019

Related U.S. Application Data
(60) Provisional application No. 62/492,968, filed on May 2, 2017.
(60) Provisional application No. 62/519,191, filed on Jun. 14, 2017.

(51) Int. Cl. H04W 80/02; H04W 28/06; H04L 29/08; H04L 12/801; H04L 1/16; H04L 1/18; H04W 76/27

(52) U.S. Cl. CPC H04W 80/02; H04W 28/065; H04L 69/324; H04W 76/27; H04L 1/1621; H04L 69/321; H04L 1/1848; H04L 47/34

(57) ABSTRACT

If there are missing RLC SDU(s) and/or missing RLC SDU segment(s), a receiving device transmits a STATUS PDU to a transmitting device in order to inform the missing RLC SDU(s) and/or missing RLC SDU segment(s). If there are multiple RLC SDU segments belonging to one RLC SDU, the STATUS PDU of the present invention one sequence number (SN) for the multiple missing RLC SDU segments, which is the same as a SN of the RLC SDU, and location information on each of the multiple missing RLC SDU segments within the RLC SDU.

### TECHNICAL FIELD

The present invention relates to a wireless communication system, and more particularly, to a method for receiving a data unit and an apparatus therefor.

### BACKGROUND ART

As an example of a mobile communication system to which the present invention is applicable, a 3rd Generation Partnership Project Long Term Evolution (hereinafter, referred to as LTE) communication system is described in brief.

FIG. 1 is a view schematically illustrating a network structure of an E-UMTS as an exemplary radio communication system. An Evolved Universal Mobile Telecommunications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Although wireless communication technology has been developed to LTE based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

As more and more communication devices demand larger communication capacity, there is a need for improved mobile broadband communication compared to existing RAT. Also, massive machine type communication (MTC), which provides various services by connecting many devices and objects, is one of the major issues to be considered in the next generation communication. In addition, a communication system design considering a service/UE sensitive to reliability and latency is being discussed. The introduction of next-generation RAT, which takes into account such advanced mobile broadband communication, massive MTC (mMCT), and ultra-reliable and low latency communication (URLLC), is being discussed.

### DISCLOSURE

### Technical Problem

Due to introduction of new radio communication technology, the number of user equipments (UEs) to which a BS should provide a service in a prescribed resource region increases and the amount of data and control information that the BS should transmit to the UEs increases. Since the amount of resources available to the BS for communication with the UE(s) is limited, a new method in which the BS efficiently receives/transmits uplink/downlink data and/or uplink/downlink control information using the limited radio resources is needed.

With development of technologies, overcoming delay or latency has become an important challenge. Applications whose performance critically depends on delay/latency are increasing. Accordingly, a method to reduce delay/latency compared to the legacy system is demanded.

Also, a method for transmitting/receiving signals effectively in a system supporting new radio access technology is required.

The technical objects that can be achieved through the present invention are not limited to what has been particularly described hereinabove and other technical objects not described herein will be more clearly understood by persons skilled in the art from the following detailed description.

### Technical Solution

In an aspect of the present invention, provided herein is a method for receiving a data unit by a receiving device in a wireless communication system. The method comprises: detecting that multiple radio link control (RLC) service data unit (SDU) segments of an RLC SDU are missing; generating, at an RLC entity of the receiving device, a status protocol data unit (PDU) for the multiple missing RLC SDU segments; and transmitting the status PDU to a transmitting side. The status PDU contains one sequence number (SN) for the multiple missing RLC SDU segments, which is the same as a SN of the RLC SDU, and location information on each of the multiple missing RLC SDU segments within the RLC SDU.

In another aspect of the present invention, provided herein is a method for transmitting a data unit by a transmitting device in a wireless communication system. The method comprises: receiving a status PDU; and transmitting a radio link control (RLC) service data unit (SDU) or RLC SDU segment indicated by the status PDU. The status PDU contains one sequence number (SN) for the multiple missing RLC SDU segments, which is the same as a SN of the RLC SDU, and location information on each of the multiple missing RLC SDU segments within the RLC SDU.

In a further aspect of the present invention, provided herein is a receiving device for receiving a data unit in a wireless communication system. The receiving device comprises a transceiver, and a processor configured to control the transceiver. The processor may be configured to: detect that multiple radio link control (RLC) service data unit (SDU) segments of an RLC SDU are missing; generate, at an RLC entity of the receiving device, a status protocol data unit (PDU) for the multiple missing RLC SDU segments; and control the transceiver to transmit the status PDU to a transmitting side. The status PDU contains one sequence number (SN) for the multiple missing RLC SDU segments, which is the same as a SN of the RLC SDU, and location information on each of the multiple missing RLC SDU segments within the RLC SDU.

In a still further aspect of the present invention, provided herein is a transmitting for transmitting a data unit in a wireless communication system. The transmitting device comprises a transceiver, and a processor configured to control the transceiver. The processor may be configured to: control the transceiver to receive a status PDU; and control the transceiver to transmit a radio link control (RLC) service data unit (SDU) or RLC SDU segment indicated by the status PDU. The status PDU contains one sequence number (SN) for the multiple missing RLC SDU segments, which is the same as a SN of the RLC SDU, and location information on each of the multiple missing RLC SDU segments within the RLC SDU.

In each aspect of the present invention, the location information may be a start offset (SOstart) and an end offset (SOend) of each missing RLC SDU segment of the RLC SDU.

In each aspect of the present invention, the status PDU may contain a first indicator (E1) field, a second indicator (E2) field and a third indicator (E3) field. The E1 field may indicates whether or not a SN (NACK_SN) for a missing RLC SDU or missing RLC SDU segment follows after the E3 field.

In each aspect of the present invention, if the E1 field indicates that a NACK_SN does not follow after the E3 field, fields after the E3 field may be associated with a latest SN before the E1 field.

In each aspect of the present invention, the E2 field may indicate whether or not a set of SOstart and SOend follow after the E3 field or a NACK_SN. The E3 field may indicate whether or not a NACK_SN range follows after the E3 field or a SOend associated with a NACK_SN indicated by a latest E1 field. If the E1 field indicates that a NACK_SN does not follow after the E3 field, if the E2 field indicates that a set of SOstart and SOend does not follow after the E3 field, and if the E3 field indicates that a SN range field follows after the E3 field, a field after the E3 field may indicate a number of consecutive NACK_SNs next to a SN of a last missing RLC SDU or RLC SDU segment indicate by a latest NACK_SN or NACK_SN range before the E1, E2 and E3 fields.

In each aspect of the present invention, the E2 field may indicate whether or not a set of SOstart and SOend follow after the E3 field or a NACK_SN. The E3 field may indicate whether or not a NACK_SN range field follows after the E3 field or a SOend associated with a NACK_SN indicated by a latest E1 field. If the E1 field indicates that a NACK_SN does not follow after the E3 field, if the E2 field indicates that a set of SOstart and SOend does not follow after the E3 field, and if the E3 field indicates that a NACK_SN range field does not follow after the E3 field, the E1, E2 and E3 fields may indicate the end of the status PDU.

In each aspect of the present invention, the receiving device may start a reassembly timer for the RLC SDU if an RLC SDU segment of the RLC SDU is first received at the RLC entity. The receiving device may generate the status PDU if the reassembly timer expires.

The above technical solutions are merely some parts of the embodiments of the present invention and various embodiments into which the technical features of the present invention are incorporated can be derived and understood by persons skilled in the art from the following detailed description of the present invention.

### Advantageous Effects

According to the present invention, radio communication signals can be efficiently transmitted/received. Therefore, overall throughput of a radio communication system can be improved.

According to an embodiment of the present invention, delay/latency occurring during communication between a user equipment and a BS may be reduced.

Also, signals in a new radio access technology system can be transmitted/received effectively.

It will be appreciated by persons skilled in the art that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention, illustrate embodiments of the invention and together with the description serve to explain the principle of the invention.

FIG. 1 is a view schematically illustrating a network structure of an E-UMTS as an exemplary radio communication system.

FIG. 2 is a block diagram illustrating network structure of an evolved universal mobile telecommunication system (E-UMTS).

FIG. 3 is a block diagram depicting architecture of a typical E-UTRAN and a typical EPC.

FIG. 4 is a diagram showing a control plane and a user plane of a radio interface protocol between a UE and an E-UTRAN based on a 3GPP radio access network standard.

FIG. 5 is a view showing an example of a physical channel structure used in an E-UMTS system.

FIG. 6 illustrates an example of RLC PDU and an example of RLC PDU segment in the LTE/LTE system.

FIG. 7 illustrates an example of STATUS PDU in the LTE/LTE system.

FIG. 8 illustrates a data flow example at a transmitting device in the LTE/LTE-A system.

FIG. 9 illustrates a data flow example at a transmitting device in the NR system.

FIG. 10 illustrates an example of starting a reassembly timer for the radio link control (RLC) service data unit (SDU) to which a received RLC SDU segment belongs.

FIG. 11 illustrates an example of generating a SEG_STATUS PDU of the present invention.

FIG. 12 and FIG. 13 illustrate an example of a STATUS PDU of the present invention in view of an RLC entity receiving RLC PDU(s) and an RLC entity transmitting RLC PDU(s), respectively.

FIG. 14 is a block diagram illustrating elements of a transmitting device 100 and a receiving device 200 for implementing the present invention.

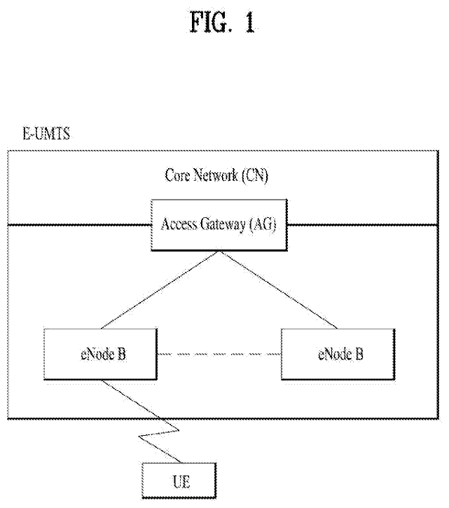

### MODE FOR INVENTION

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

In some instances, known structures and devices are omitted or are shown in block diagram form, focusing on important features of the structures and devices, so as not to obscure the concept of the present invention. The same reference numbers will be used throughout this specification to refer to the same or like parts.

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE. For convenience of description, it is assumed that the present invention is applied to 3GPP based wireless communication system. However, the technical features of the present invention are not limited thereto. For example, although the following detailed description is given based on a mobile communication system corresponding to a 3GPP based system, aspects of the present invention that are not limited to 3GPP based system are applicable to other mobile communication systems.

For example, the present invention is applicable to contention based communication such as Wi-Fi as well as non-contention based communication as in the 3GPP based system in which an eNB allocates a DL/UL time/frequency resource to a UE and the UE receives a DL signal and transmits a UL signal according to resource allocation of the eNB. In a non-contention based communication scheme, an access point (AP) or a control node for controlling the AP allocates a resource for communication between the UE and the AP, whereas, in a contention based communication scheme, a communication resource is occupied through contention between UEs which desire to access the AP. The contention based communication scheme will now be described in brief. One type of the contention based communication scheme is carrier sense multiple access (CSMA). CSMA refers to a probabilistic media access control (MAC) protocol for confirming, before a node or a communication device transmits traffic on a shared transmission medium (also called a shared channel) such as a frequency band, that there is no other traffic on the same shared transmission medium. In CSMA, a transmitting device determines whether another transmission is being performed before attempting to transmit traffic to a receiving device. In other words, the transmitting device attempts to detect presence of a carrier from another transmitting device before attempting to perform transmission. Upon sensing the carrier, the transmitting device waits for another transmission device which is performing transmission to finish transmission, before performing transmission thereof. Consequently, CSMA can be a communication scheme based on the principle of “sense before transmit” or “listen before talk”. A scheme for avoiding collision between transmitting devices in the contention based communication system using CSMA includes carrier sense multiple access with collision detection (CSMA/CD) and/or carrier sense multiple access with collision avoidance (CSMA/CA). CSMA/CD is a collision detection scheme in a wired local area network (LAN) environment. In CSMA/CD, a personal computer (PC) or a server which desires to perform communication in an Ethernet environment first confirms whether communication occurs on a network and, if another device carries data on the network, the PC or the server waits and then transmits data. That is, when two or more users (e.g. PCs, UEs, etc.) simultaneously transmit data, collision occurs between simultaneous transmission and CSMA/CD is a scheme for flexibly transmitting data by monitoring collision. A transmitting device using CSMA/CD adjusts data transmission thereof by sensing data transmission performed by another device using a specific rule. CSMA/CA is a MAC protocol specified in IEEE 802.11 standards. A wireless LAN (WLAN) system conforming to IEEE 802.11 standards does not use CSMA/CD which has been used in IEEE 802.3 standards and uses CA, i.e. a collision avoidance scheme. Transmission devices always sense carrier of a network and, if the network is empty, the transmission devices wait for determined time according to locations thereof registered in a list and then transmit data. Various methods are used to determine priority of the transmission devices in the list and to reconfigure priority. In a system according to some versions of IEEE 802.11 standards, collision may occur and, in this case, a collision sensing procedure is performed. A transmission device using CSMA/CA avoids collision between data transmission thereof and data transmission of another transmission device using a specific rule.

In the present invention, the term “assume” may mean that a subject to transmit a channel transmits the channel in accordance with the corresponding “assumption.” This may also mean that a subject to receive the channel receives or decodes the channel in a form conforming to the “assumption,” on the assumption that the channel has been transmitted according to the “assumption.”

In the present invention, a user equipment (UE) may be a fixed or mobile device. Examples of the UE include various devices that transmit and receive user data and/or various kinds of control information to and from a base station (BS). The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present invention, a BS generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc. Especially, a BS of the UMTS is referred to as a NB, a BS of the EPC/LTE is referred to as an eNB, and a BS of the new radio (NR) system is referred to as a gNB.

In the present invention, a node refers to a fixed point capable of transmitting/receiving a radio signal through communication with a UE. Various types of eNBs may be used as nodes irrespective of the terms thereof. For example, a BS, a node B (NB), an e-node B (eNB), a pico-cell eNB (PeNB), a home eNB (HeNB), a relay, a repeater, etc. may be a node. In addition, the node may not be an eNB. For example, the node may be a radio remote head (RRH) or a radio remote unit (RRU). The RRH or RRU generally has a lower power level than a power level of an eNB. Since the RRH or RRU (hereinafter, RRH/RRU) is generally connected to the eNB through a dedicated line such as an optical cable, cooperative communication between RRH/RRU and the eNB can be smoothly performed in comparison with cooperative communication between eNBs connected by a radio line. At least one antenna is installed per node. The antenna may mean a physical antenna or mean an antenna port or a virtual antenna.

In the present invention, a cell refers to a prescribed geographical area to which one or more nodes provide a communication service. Accordingly, in the present invention, communicating with a specific cell may mean communicating with an eNB or a node which provides a communication service to the specific cell. In addition, a DL/UL signal of a specific cell refers to a DL/UL signal from/to an eNB or a node which provides a communication service to the specific cell. A node providing UL/DL communication services to a UE is called a serving node and a cell to which UL/DL communication services are provided by the serving node is especially called a serving cell.

Meanwhile, a 3GPP based system uses the concept of a cell in order to manage radio resources and a cell associated with the radio resources is distinguished from a cell of a geographic region.

A “cell” of a geographic region may be understood as coverage within which a node can provide service using a carrier and a “cell” of a radio resource is associated with bandwidth (BW) which is a frequency range configured by the carrier. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of a radio resource used by the node. Accordingly, the term “cell” may be used to indicate service coverage of the node sometimes, a radio resource at other times, or a range that a signal using a radio resource can reach with valid strength at other times.

Meanwhile, the recent 3GPP based wireless communication standard uses the concept of a cell to manage radio resources. The “cell” associated with the radio resources is defined by combination of downlink resources and uplink resources, that is, combination of DL component carrier (CC) and UL CC. The cell may be configured by downlink resources only, or may be configured by downlink resources and uplink resources. If carrier aggregation is supported, linkage between a carrier frequency of the downlink resources (or DL CC) and a carrier frequency of the uplink resources (or UL CC) may be indicated by system information. For example, combination of the DL resources and the UL resources may be indicated by linkage of system information block type 2 (SIB2). In this case, the carrier frequency means a center frequency of each cell or CC. A cell operating on a primary frequency may be referred to as a primary cell (Pcell) or PCC, and a cell operating on a secondary frequency may be referred to as a secondary cell (Scell) or SCC. The carrier corresponding to the Pcell on downlink will be referred to as a downlink primary CC (DL PCC), and the carrier corresponding to the Pcell on uplink will be referred to as an uplink primary CC (UL PCC). A Scell means a cell that may be configured after completion of radio resource control (RRC) connection establishment and used to provide additional radio resources. The Scell may form a set of serving cells for the UE together with the Pcell in accordance with capabilities of the UE. The carrier corresponding to the Scell on the downlink will be referred to as downlink secondary CC (DL SCC), and the carrier corresponding to the Scell on the uplink will be referred to as uplink secondary CC (UL SCC). Although the UE is in RRC-CONNECTED state, if it is not configured by carrier aggregation or does not support carrier aggregation, a single serving cell configured by the Pcell only exists.

In the present invention, “PDCCH” refers to a PDCCH, an EPDCCH (in subframes when configured), a MTC PDCCH (MPDCCH), for an RN with R-PDCCH configured and not suspended, to the R-PDCCH or, for NB-IoT to the narrowband PDCCH (NPDCCH).

In the present invention, monitoring a channel implies attempting to decode the channel For example, monitoring a PDCCH implies attempting to decode PDCCH(s) (or PDCCH candidates).

In the present invention, for dual connectivity operation the term “special Cell” refers to the PCell of the master cell group (MCG) or the PSCell of the secondary cell group (SCG), otherwise the term Special Cell refers to the PCell. The MCG is a group of serving cells associated with a master eNB (MeNB) which terminates at least S1-MME, and the SCG is a group of serving cells associated with a secondary eNB (SeNB) that is providing additional radio resources for the UE but is not the MeNB. The SCG is comprised of a primary SCell (PSCell) and optionally one or more SCells. In dual connectivity, two MAC entities are configured in the UE: one for the MCG and one for the SCG. Each MAC entity is configured by RRC with a serving cell supporting PUCCH transmission and contention based Random Access. In this specification, the term SpCell refers to such cell, whereas the term SCell refers to other serving cells. The term SpCell either refers to the PCell of the MCG or the PSCell of the SCG depending on if the MAC entity is associated to the MCG or the SCG, respectively.

In the present invention, “C-RNTI” refers to a cell RNTI, “SI-RNTI” refers to a system information RNTI, “P-RNTI” refers to a paging RNTI, “RA-RNTI” refers to a random access RNTI, “SC-RNTI” refers to a single cell RNTI”, “SL-RNTI” refers to a sidelink RNTI, and “SPS C-RNTI” refers to a semi-persistent scheduling C-RNTI.

For terms and technologies which are not specifically described among the terms of and technologies employed in this specification, 3GPP LTE/LTE-A standard documents, for example, 3GPP TS 36.211, 3GPP TS 36.212, 3GPP TS 36.213, 3GPP TS 36.300, 3GPP TS 36.321, 3GPP TS 36.322, 3GPP TS 36.323 and 3GPP TS 36.331, and 3GPP NR standard documents, for example, 3GPP TS 38.211, 3GPP TS 38.213, 3GPP TS 38.214, 3GPP TS 38.300, 3GPP TS 38.321, 3GPP TS 38.322, 3GPP TS 38.323 and 3GPP TS 38.331 may be referenced.

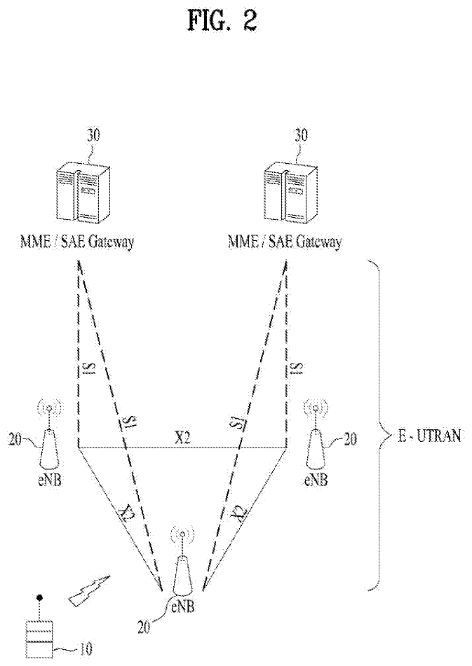

FIG. 2 is a block diagram illustrating network structure of an evolved universal mobile telecommunication system (E-UMTS). The E-UMTS may be also referred to as an LTE system. The communication network is widely deployed to provide a variety of communication services such as voice (VoIP) through IMS and packet data.

As illustrated in FIG. 2, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNB 20 to UE 10, and “uplink” refers to communication from the UE to an eNB.

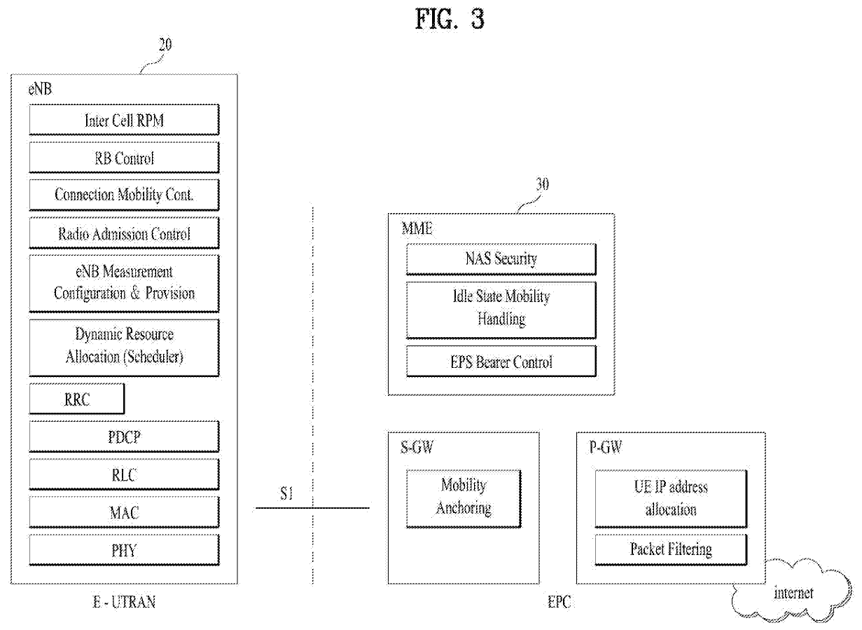

FIG. 3 is a block diagram depicting architecture of a typical E-UTRAN and a typical EPC.

As illustrated in FIG. 3, an eNB 20 provides end points of a user plane and a control plane to the UE 10. MME/SAE gateway 30 provides an end point of a session and mobility management function for UE 10. The eNB and MME/SAE gateway may be connected via an S1 interface.

The eNB 20 is generally a fixed station that communicates with a UE 10, and may also be referred to as a base station (BS) or an access point. One eNB 20 may be deployed per cell. An interface for transmitting user traffic or control traffic may be used between eNBs 20.

The MME provides various functions including NAS signaling to eNBs 20, NAS signaling security, AS Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, roaming, authentication, bearer management functions including dedicated bearer establishment, support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and an SAE gateway.

A plurality of nodes may be connected between eNB 20 and gateway 30 via the S1 interface. The eNBs 20 may be connected to each other via an X2 interface and neighboring eNBs may have a meshed network structure that has the X2 interface.

As illustrated, eNB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNB measurements, radio bearer control, radio admission control (RAC), and connection mobility control in LTE_ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

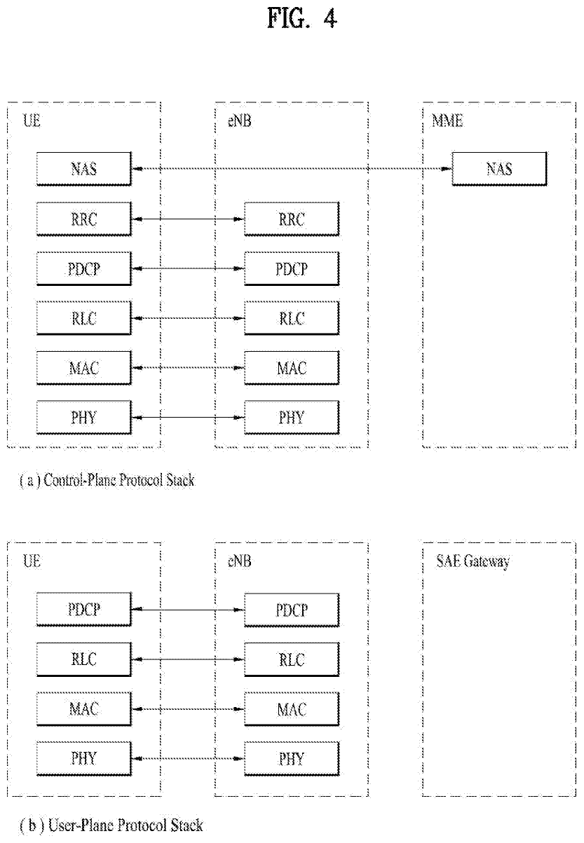

FIG. 4 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

Layer 1 (i.e. L1) of the 3GPP LTE/LTE-A system is corresponding to a physical layer. A physical (PHY) layer of a first layer (Layer 1 or L1) provides an information transfer service to a higher layer using a physical channel The PHY layer is connected to a medium access control (MAC) layer located on the higher layer via a transport channel. Data is transported between the MAC layer and the PHY layer via the transport channel. Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

Layer 2 (i.e. L2) of the 3GPP LTE/LTE-A system is split into the following sublayers: Medium Access Control (MAC), Radio Link Control (RLC) and Packet Data Convergence Protocol (PDCP). The MAC layer of a second layer (Layer 2 or L2) provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

The main services and functions of the MAC sublayer include: mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ; priority handling between logical channels of one UE; priority handling between UEs by means of dynamic scheduling; MBMS service identification; transport format selection; and padding.

The main services and functions of the RLC sublayer include: transfer of upper layer protocol data units (PDUs); error correction through ARQ (only for acknowledged mode (AM) data transfer); concatenation, segmentation and reassembly of RLC service data units (SDUs) (only for unacknowledged mode (UM) and acknowledged mode (AM) data transfer); re-segmentation of RLC data PDUs (only for AM data transfer); reordering of RLC data PDUs (only for UM and AM data transfer); duplicate detection (only for UM and AM data transfer); protocol error detection (only for AM data transfer); RLC SDU discard (only for UM and AM data transfer); and RLC re-establishment, except for a NB-IoT UE that only uses Control Plane CIoT EPS optimizations. Radio Bearers are not characterized by a fixed sized data unit (e.g. a fixed sized RLC PDU).

The main services and functions of the PDCP sublayer for the user plane include: header compression and decompression: ROHC only; transfer of user data; in-sequence delivery of upper layer PDUs at PDCP re-establishment procedure for RLC AM; for split bearers in DC and LWA bearers (only support for RLC AM): PDCP PDU routing for transmission and PDCP PDU reordering for reception; duplicate detection of lower layer SDUs at PDCP re-establishment procedure for RLC AM; retransmission of PDCP SDUs at handover and, for split bearers in DC and LWA bearers, of PDCP PDUs at PDCP data-recovery procedure, for RLC AM; ciphering and deciphering; timer-based SDU discard in uplink. The main services and functions of the PDCP for the control plane include: ciphering and integrity protection; and transfer of control plane data. For split and LWA bearers, PDCP supports routing and reordering. For DRBs mapped on RLC AM and for LWA bearers, the PDCP entity uses the reordering function when the PDCP entity is associated with two AM RLC entities, when the PDCP entity is configured for a LWA bearer; or when the PDCP entity is associated with one AM RLC entity after it was, according to the most recent reconfiguration, associated with two AM RLC entities or configured for a LWA bearer without performing PDCP re-establishment.

Layer 3 (i.e. L3) of the LTE/LTE-A system includes the following sublayers: Radio Resource Control (RRC) and Non Access Stratum (NAS). A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other. The non-access stratum (NAS) layer positioned over the RRC layer performs functions such as session management and mobility management.

Radio bearers are roughly classified into (user) data radio bearers (DRBs) and signaling radio bearers (SRBs). SRBs are defined as radio bearers (RBs) that are used only for the transmission of RRC and NAS messages.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

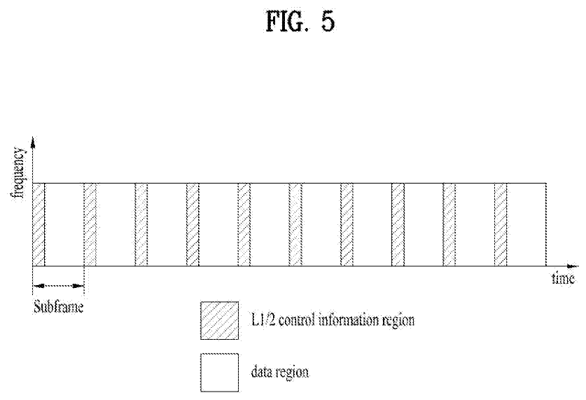

FIG. 5 is a view showing an example of a physical channel structure used in an E-UMTS system. A physical channel includes several subframes on a time axis and several subcarriers on a frequency axis. Here, one subframe includes a plurality of symbols on the time axis. One subframe includes a plurality of resource blocks and one resource block includes a plurality of symbols and a plurality of subcarriers. In addition, each subframe may use certain subcarriers of certain symbols (e.g., a first symbol) of a subframe for a physical downlink control channel (PDCCH), that is, an L1/L2 control channel. The PDCCH carries scheduling assignments and other control information. In FIG. 5, an L1/L2 control information transmission area (PDCCH) and a data area (PDSCH) are shown. In one embodiment, a radio frame of 10 ms is used and one radio frame includes 10 subframes. In addition, one subframe includes two consecutive slots. The length of one slot may be 0.5 ms. In addition, one subframe includes a plurality of OFDM symbols and a portion (e.g., a first symbol) of the plurality of OFDM symbols may be used for transmitting the L1/L2 control information.

A time interval in which one subframe is transmitted is defined as a transmission time interval (TTI). Time resources may be distinguished by a radio frame number (or radio frame index), a subframe number (or subframe index), a slot number (or slot index), and the like. TTI refers to an interval during which data may be scheduled. For example, in the 3GPP LTE/LTE-A system, an opportunity of transmission of an UL grant or a DL grant is present every 1 ms, and the UL/DL grant opportunity does not exists several times in less than 1 ms. Therefore, the TTI in the legacy 3GPP LTE/LTE-A system is lms.

A base station and a UE mostly transmit/receive data via a PDSCH, which is a physical channel, using a DL-SCH which is a transmission channel, except a certain control signal or certain service data. Information indicating to which UE (one or a plurality of UEs) PDSCH data is transmitted and how the UE receive and decode PDSCH data is transmitted in a state of being included in the PDCCH.

For example, in one embodiment, a certain PDCCH is CRC-masked with a radio network temporary identity (RNTI) “A” and information about data is transmitted using a radio resource “B” (e.g., a frequency location) and transmission format information “C” (e.g., a transmission block size, modulation, coding information or the like) via a certain subframe. Then, one or more UEs located in a cell monitor the PDCCH using its RNTI information. And, a specific UE with RNTI “A” reads the PDCCH and then receive the PDSCH indicated by B and C in the PDCCH information. In the present invention, a PDCCH addressed to a certain RNTI means that the PDCCH is CRC-masked with the certain RNTI. A UE may attempt to decode a PDCCH using the certain RNTI if the UE is monitoring a PDCCH addressed to the certain RNTI.

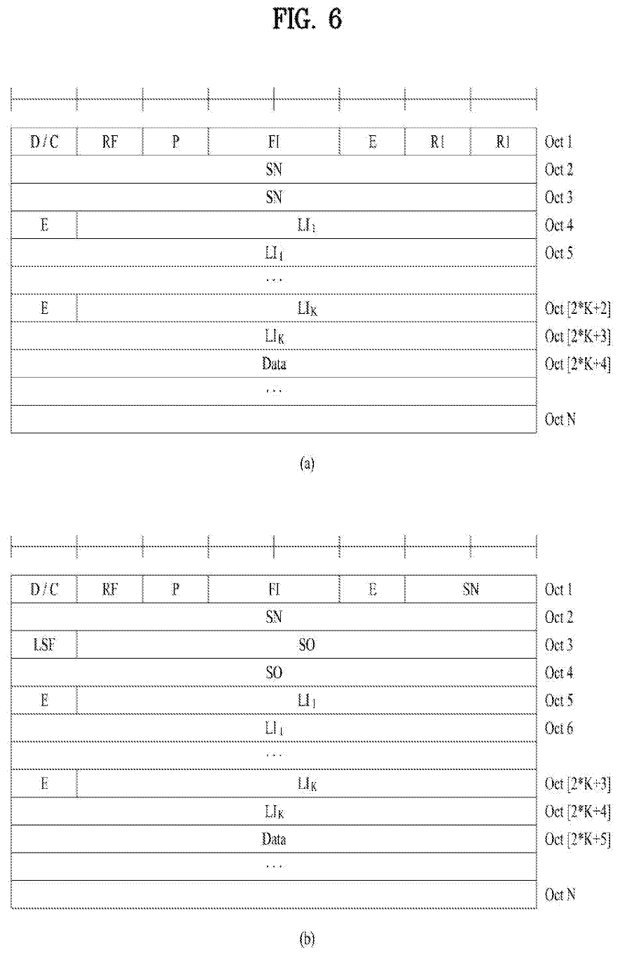

FIG. 6 illustrates an example of RLC PDU and an example of RLC PDU segment in the LTE/LTE system. Especially, FIG. 6(a) illustrates an acknowledged mode data (AMD) PDU with 16 bit sequence number (SN) and FIG. 6(b) illustrates an AMD PDU segment 10 bit SN.

RLC PDUs can be categorized into RLC data PDUs and RLC control PDUs. RLC data PDUs in are used by transparent mode (TM), unacknowledged mode (UM) and acknowledged mode (AM) RLC entities to transfer upper layer PDUs (i.e. RLC SDUs). In LTE, AMD PDU segment is used to transfer upper layer PDUs by an AM RLC entity. It is used when the AM RLC entity needs to retransmit a portion of an AMD PDU. RLC control PDUs are used by AM RLC entity to perform ARQ procedures.

In the LTE/LTE-A system, the ARQ within the RLC sublayer has the following characteristics: ARQ retransmits RLC PDUs or RLC PDU segments based on RLC status reports; polling for RLC status report is used when needed by RLC; RLC receiver can also trigger RLC status report after detecting a missing RLC PDU or RLC PDU segment. When retransmitting a portion of an AMD PDU, the transmitting side of an AM RLC entity shall segment the portion of the AMD PDU as necessary, form a new AMD PDU segment which will fit within the total size of RLC PDU(s) indicated by lower layer at the particular transmission opportunity and deliver the new AMD PDU segment to lower layer. In LTE, segmentation for AMD PDU can occur for retransmission but does not occur for new transmission (i.e. initial transmission).When forming a new AMD PDU segment, the transmitting side of an AM RLC entity shall: only map the Data field of the original AMD PDU to the Data field of the new AMD PDU segment; set the header of the new AMD PDU segment; and set the P field.

RLC PDU is a bit string. In FIG. 6, bit strings are represented by tables in which the first and most significant bit is the left most bit of the first line of the table, the last and least significant bit is the rightmost bit of the last line of the table, and more generally the bit string is to be read from left to right and then in the reading order of the lines. RLC SDUs are bit strings that are byte aligned (i.e. multiple of 8 bits) in length. An RLC SDU is included into an RLC PDU from first bit onward.

As shown in FIG. 6(a), AMD PDU consists of a Data field and an AMD PDU header. AMD PDU header consists of a fixed part (fields that are present for every AMD PDU) and an extension part (fields that are present for an AMD PDU when necessary). The fixed part of the AMD PDU header itself is byte aligned and consists of a D/C, a RF, a P, a FI, an E and a SN. The extension part of the AMD PDU header itself is byte aligned and consists of E(s) and LI(s). An AM RLC entity is configured by RRC to use either a 10 bit SN or a 16 bit SN. The length of the fixed part of the AMD PDU header is two and three bytes respectively. The default values for SN field length used by an AM RLC entity is 10 bits. An AMD PDU header consists of an extension part only when more than one Data field elements are present in the AMD PDU, in which case an E and a LI are present for every Data field element except the last. Furthermore, when an AMD PDU header consists of an odd number of LI(s) and the length of the LI field is 11 bits, four padding bits follow after the last LI. The default value for LI field length used by an AM RLC entity is 11 bits.

As shown in FIG. 6(b), AMD PDU segment consists of a Data field and an AMD PDU segment header. AMD PDU segment header consists of a fixed part (fields that are present for every AMD PDU segment) and an extension part (fields that are present for an AMD PDU segment when necessary). The fixed part of the AMD PDU segment header itself is byte aligned and consists of a D/C, a RF, a P, a FI, an E, a SN, a LSF and a SO. The extension part of the AMD PDU segment header itself is byte aligned and consists of E(s) and LI(s). AM RLC entity is configured by RRC to use either a 10 bit SN or a 16 bit SN. When a 10 bit SN is used, the SO field is 15 bits, and when a 16 bit SN is used, the SO field is 16 bits. The length of the fixed part of the AMD PDU segment header is four and five bytes respectively. The default values for SN field length and SO field length used by an AM RLC entity are 10 bits and 15 bits, respectively. An AMD PDU segment header consists of an extension part only when more than one Data field elements are present in the AMD PDU segment, in which case an E and a LI are present for every Data field element except the last. Furthermore, when an AMD PDU segment header consists of an odd number of LI(s) and the length of the LI field is 11 bits, four padding bits follow after the last LI. The default value for LI field length used by an AM RLC entity is 11 bits.

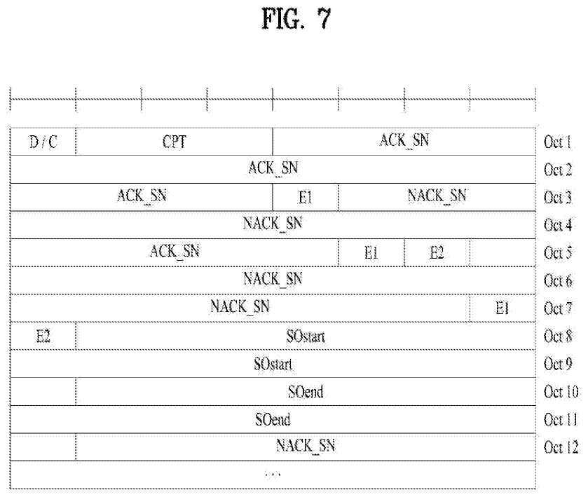

FIG. 7 illustrates an example of STATUS PDU in the LTE/LTE system.

STATUS PDU is used by the receiving side of an AM RLC entity to inform the peer AM RLC entity about RLC data PDUs that are received successfully, and RLC data PDUs that are detected to be lost by the receiving side of an AM RLC entity.

Hereinafter, parameters shown in FIG. 6 and FIG. 7 are described. In each field in RLC PDU, the bits in the parameters are represented in which the first and most significant bit is the left most bit and the last and least significant bit is the rightmost bit. Unless mentioned otherwise, integers are encoded in standard binary encoding for unsigned integers.

Data field elements are mapped to the Data field in the order which they arrive to the RLC entity at the transmitter.

The sequence number (SN) field indicates the sequence number of the corresponding UMD or AMD PDU. For an AMD PDU segment, the SN field indicates the sequence number of the original AMD PDU from which the AMD PDU segment was constructed from. The sequence number is incremented by one for every UMD or AMD PDU.

The extension (E) field indicates whether Data field follows or a set of E field and LI field follows. The interpretation of the E field is provided in the following tables. Table 1 shows the E1 field interpreation for E field in the fixed part of the header, and Table 2 shows the E1 field interpretation for E1 field in the extension part of the header.

TABLE 1

| Value | Description |
|---|---|
| 0 | Data field follows from the octet following |
| | the fixed part of the header |
| 1 | A set of E field and LI field follows from the octet |
| | following the fixed part of the header |

TABLE 2

| Value | Description |
|---|---|
| 0 | Data field follows from the octet following the |
| | LI field following this E field |
| 1 | A set of E field and LI field follows from the |
| | bit following the LI field following this E field |

The length indicator (LI) field indicates the length in bytes of the corresponding Data field element present in the RLC data PDU delivered/received by an UM or an AM RLC entity. The first LI present in the RLC data PDU header corresponds to the first Data field element present in the Data field of the RLC data PDU, the second LI present in the RLC data PDU header corresponds to the second Data field element present in the Data field of the RLC data PDU, and so on. The value 0 is reserved. The framing info (FI) field indicates whether an RLC SDU is segmented at the beginning and/or at the end of the Data field. Specifically, the FI field indicates whether the first byte of the Data field corresponds to the first byte of an RLC SDU, and whether the last byte of the Data field corresponds to the last byte of an RLC SDU. The interpretation of the FI field is provided in the following table.

TABLE 3

| Value | Description |
|---|---|
| 00 | First byte of the Data field corresponds to the first byte |
| | of a RLC SDU. Last byte of the Data field corresponds |
| | to the last byte of a RLC SDU. |
| 01 | First byte of the Data field corresponds to the first byte |
| | of a RLC SDU. Last byte of the Data field does not |
| | correspond to the last byte of a RLC SDU. |
| 10 | First byte of the Data field does not correspond to the |
| | first byte of a RLC SDU. Last byte of the Data field |
| | corresponds to the last byte of a RLC SDU. |
| 11 | First byte of the Data field does not correspond to the |
| | first byte of a RLC SDU. Last byte of the Data field |
| | does not correspond to the last byte of a RLC SDU. |

The segment offset (SO) field indicates the position of the AMD PDU segment in bytes within the original AMD PDU. Specifically, the SO field indicates the position within the Data field of the original AMD PDU to which the first byte of the Data field of the AMD PDU segment corresponds to. The first byte in the Data field of the original AMD PDU is referred by the SO field value “000000000000000” or “0000000000000000”, i.e., numbering starts at zero. The last segment flag (LSF) field indicates whether or not the last byte of the AMD PDU segment corresponds to the last byte of an AMD PDU. The interpretation of the LSF field is provided in the following table.

TABLE 4

| Value | Description |
|---|---|
| 0 | Last byte of the AMD PDU segment does not correspond |
| | to the last byte of an AMD PDU. |
| 1 | Last byte of the AMD PDU segment corresponds to |
| | the last byte of an AMD PDU. |

The data/control (D/C) field indicates whether the RLC PDU is a RLC data PDU or RLC control PDU. The interpretation of the D/C field is provided in the following table.

TABLE 5

| Value | Description |
|---|---|
| 0 | Control PDU |
| 1 | Data PDU |

The re-segmentation flag (RF) field indicates whether the RLC PDU is an AMD PDU or AMD PDU segment. The interpretation of the RF field is provided in the following table.

TABLE 6

| Value | Description |
|---|---|
| 0 | AMD PDU |
| 1 | AMD PDU segment |

The polling bit (P) field indicates whether or not the transmitting side of an AM RLC entity requests a STATUS report from its peer AM RLC entity. The interpretation of the P field is provided in the following table.

TABLE 7

| Value | Description |
|---|---|
| 0 | Status report not requested |
| 1 | Status report is requested |

The control PDU type (CPT) field indicates the type of the RLC control PDU. The interpretation of the CPT field is provided in the following table.

TABLE 8

| Value | Description |
|---|---|
| 000 | STATUS PDU |
| 001-111 | Reserved(PDUs with this coding will |
| | be discarded by the receiving |
| | entity for this release of the protocol) |

An acknowledgement SN (ACK_SN) field has a length of 10 bits or 16 bits (configurable). The ACK_SN field indicates the SN of the next not received RLC Data PDU which is not reported as missing in the STATUS PDU. When the transmitting side of an AM RLC entity receives a STATUS PDU, it interprets that all AMD PDUs up to but not including the AMD PDU with SN=ACK_SN have been received by its peer AM RLC entity, excluding those AMD PDUs indicated in the STATUS PDU with NACK_SN and portions of AMD PDUs indicated in the STATUS PDU with NACK_SN, SOstart and SOend. The extention bit 1 (E1) field indicates whether or not a set of NACK_SN, E1 and E2 follows. The interpretation of the E1 field is provided in the following table.

TABLE 9

| Value | Description |
|---|---|
| 0 | A set of NACK_SN, E1 and E2 does not follow. |
| 1 | A set of NACK_SN, E1 and E2 follows. |

A negative acknowledgement SN (NACK_SN) field has a length of 10 bits or 16 bits (configurable). The NACK_SN field indicates the SN of the AMD PDU (or portions of it) that has been detected as lost at the receiving side of the AM RLC entity. The extention bit 2 (E2) field indicates whether or not a set of SOstart and SOend follows. The interpretation of the E2 field is provided in the following table.

TABLE 10

| Value | Description |
|---|---|
| 0 | A set of SOstart and SOend does not follow for this NACK_SN. |
| 1 | A set of SOstart and SOend follows for this NACK_SN. |

An SO start (SOstart) field has a length of 15 bits or 16 bits (configurable). The SOstart field (together with the SOend field) indicates the portion of the AMD PDU with SN=NACK_SN (the NACK_SN for which the SOstart is related to) that has been detected as lost at the receiving side of the AM RLC entity. Specifically, the SOstart field indicates the position of the first byte of the portion of the AMD PDU in bytes within the Data field of the AMD PDU. The first byte in the Data field of the original AMD PDU is referred by the SOstart field value “000000000000000” or “0000000000000000”, i.e., numbering starts at zero.An SO end (SOend) field has a length of 15 bits or 16 bits (configurable). The SOend field (together with the SOstart field) indicates the portion of the AMD PDU with SN=NACK_SN (the NACK_SN for which the SOend is related to) that has been detected as lost at the receiving side of the AM RLC entity. Specifically, the SOend field indicates the position of the last byte of the portion of the AMD PDU in bytes within the Data field of the AMD PDU. The first byte in the Data field of the original AMD PDU is referred by the SOend field value “000000000000000” or “0000000000000000”, i.e., numbering starts at zero. The special SOend value “111111111111111” or “1111111111111111” is used to indicate that the missing portion of the AMD PDU includes all bytes to the last byte of the AMD PDU.

In the LTE/LTE-A system, ARQ procedures are only performed by an AM RLC entity. An AM RLC entity sends STATUS PDUs to its peer AM RLC entity in order to provide positive and/or negative acknowledgements of RLC PDUs (or portions of them). Except for NB-IoT, RRC configures whether or not the status prohibit function is to be used for an AM RLC entity. For NB-IoT, RRC configures whether or not the status reporting due to detection of reception failure of a RLC data PDU is to be used for an AM RLC entity. Triggers to initiate STATUS reporting include:

>Polling from its peer AM RLC entity:

>>When a RLC data PDU with SN=x and the P field set to “1” is received from lower layer, the receiving side of an AM RLC entity shall:

>>>if the PDU is to be discarded; or

>>>if x<VR(MS) or x>=VR(MR):

>>>>trigger a STATUS report;

>>>else:

>>>>delay triggering the STATUS report until x<VR(MS) or x>=VR(MR).

NOTE 1: This ensures that the RLC Status report is transmitted after HARQ reordering.

>Detection of reception failure of a RLC data PDU, except for an NB-IoT UE not configured with enableStatusReportSN-Gap:

>>The receiving side of an AM RLC entity shall trigger a STATUS report when t-Reordering expires.

NOTE 2: The expiry of t-Reordering triggers both VR(MS) to be updated and a STATUS report to be triggered, but the STATUS report shall be triggered after VR(MS) is updated. VR(MS) and VR(MR) are state variables maintained at each receiving AM RLC entity. The maximum STATUS transmit state variable VR(MS) holds the highest possible value of the SN which can be indicated by “ACK_SN” when a STATUS PDU needs to be constructed, and it is initially set to 0. The maximum acceptable receive state variable VR(MR) equals VR(R)+AM_Window_Size, and it holds the value of the SN of the first AMD PDU that is beyond the receiving window and serves as the higher edge of the receiving window, where AM_Window_Size=512 when a 10 bit SN is used, AM_Window_Size=32768 when a 16 bit SN is used. The receive state variable VR(R) maintained at each AM RLC entity holds the value of the SN following the last in-sequence completely received AMD PDU, and it serves as the lower edge of the receiving window. VR(R) is initially set to 0, and is updated whenever the AM RLC entity receives an AMD PDU with SN=VR(R).

When STATUS reporting has been triggered, the receiving side of an AM RLC entity shall:

>if t-StatusProhibit is not running:

>>at the first transmission opportunity indicated by lower layer, construct a STATUS PDU and deliver it to lower layer;

>else:

>>at the first transmission opportunity indicated by lower layer after t-StatusProhibit expires, construct a single STATUS PDU even if status reporting was triggered several times while t-StatusProhibit was running and deliver it to lower layer;

When a STATUS PDU has been delivered to lower layer, the receiving side of an AM RLC entity shall:

>start t-StatusProhibit.

The timer t-StatusProhibit is used by the receiving side of an AM RLC entity in order to prohibit transmission of a STATUS PDU, and it is configured by RRC.

When constructing a STATUS PDU, the AM RLC entity shall:

>for the AMD PDUs with SN such that VR(R) <=SN<VR(MS) that has not been completely received yet, in increasing SN order of PDUs and increasing byte segment order within PDUs, starting with SN=VR(R) up to the point where the resulting STATUS PDU still fits to the total size of RLC PDU(s) indicated by lower layer:

>>for an AMD PDU for which no byte segments have been received yet:

>>>include in the STATUS PDU a NACK_SN which is set to the SN of the AMD PDU;

>>for a continuous sequence of byte segments of a partly received AMD PDU that have not been received yet:

>>>include in the STATUS PDU a set of NACK_SN, SOstart and SOend

>set the ACK_SN to the SN of the next not received RLC Data PDU which is not indicated as missing in the resulting STATUS PDU.

The transmitting side of an AM RLC entity can receive a negative acknowledgement (notification of reception failure by its peer AM RLC entity) for an AMD PDU or a portion of an AMD PDU by STATUS PDU from its peer AM RLC entity. When receiving a negative acknowledgement for an AMD PDU or a portion of an AMD PDU by a STATUS PDU from its peer AM RLC entity, the transmitting side of the AM RLC entity could consider the AMD PDU or the portion of the AMD PDU for which a negative acknowledgement was received for retransmission. When retransmitting an AMD PDU, the transmitting side of an AM RLC entity shall:

>if the AMD PDU can entirely fit within the total size of RLC PDU(s) indicated by lower layer at the particular transmission opportunity:

>>deliver the AMD PDU as it is except for the P field to lower layer;

>otherwise:

>>segment the AMD PDU, form a new AMD PDU segment which will fit within the total size of RLC PDU(s) indicated by lower layer at the particular transmission opportunity and deliver the new AMD PDU segment to lower layer.

When retransmitting a portion of an AMD PDU, the transmitting side of an AM RLC entity shall:

>segment the portion of the AMD PDU as necessary, form a new AMD PDU segment which will fit within the total size of RLC PDU(s) indicated by lower layer at the particular transmission opportunity and deliver the new AMD PDU segment to lower layer.

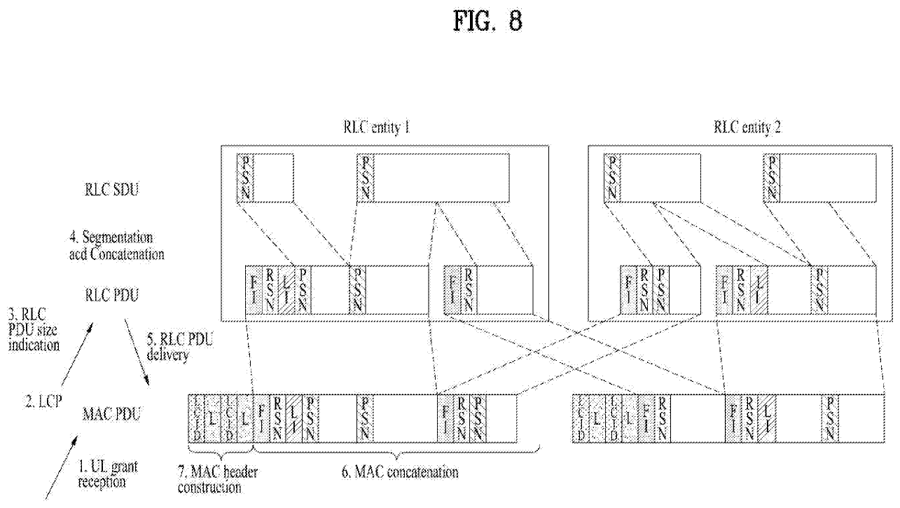

FIG. 8 illustrates a data flow example at a transmitting device in the LTE/LTE-A system. Especially, FIG. 8 shows an uplink (UL) data flow example where a UE is a transmitting side and a BS or network is a receiving side. A downlink (DL) data flow is similar to the UL data flow, except that a UE should receive a UL grant used for UL MAC PDU transmission while a BS does not have to receive a DL grant used for DL MAC PDU transmission but can allocate it for itself.

Referring to FIG. 8, in LTE, a MAC PDU construction process at a UE starts when a UL grant is received, as follows.

>1. The UE receives a UL grant from an eNB.

>2. The MAC entity performs Logical Channel Prioritization (LCP) procedure to determine the RLC PDU size for each RLC entity.

>3. The MAC entity indicates the determined RLC PDU size to each RLC entity.

>4. Each RLC entity performs segmentation and/or concatenation of RLC SDUs to construct a RLC PDU. For each RLC PDU, Framing Info (FI) and RLC Sequence Number (RSN) are mandatorily present. The Length Indicator (LI) is included each time two RLC SDUs (segments) are concatenated.

>5. Each RLC entity delivers the constructed RLC PDU to the MAC entity.

>6. The MAC entity concatenates RLC PDUs received from multiple RLC entities.

>7. The MAC entity sets the value of MAC subheader for each MAC SDU, and collects all MAC subheaders in front of the MAC PDU to form a MAC header.

A fully mobile and connected society is expected in the near future, which will be characterized by a tremendous amount of growth in connectivity, traffic volume and a much broader range of usage scenarios. Some typical trends include explosive growth of data traffic, great increase of connected devices and continuous emergence of new services. Besides the market requirements, the mobile communication society itself also requires a sustainable development of the eco-system, which produces the needs to further improve system efficiencies, such as spectrum efficiency, energy efficiency, operational efficiency and cost efficiency. To meet the above ever-increasing requirements from market and mobile communication society, next generation access technologies are expected to emerge in the near future.

Building upon its success of IMT-2000 (3G) and IMT-Advanced (4G), 3GPP has been devoting its effort to IMT-2020 (5G) development since September 2015. 5G New Radio (NR) is expected to expand and support diverse use case scenarios and applications that will continue beyond the current IMT-Advanced standard, for instance, enhanced Mobile Broadband (eMBB), Ultra Reliable Low Latency Communication (URLLC) and massive Machine Type Communication (mMTC). eMBB is targeting high data rate mobile broadband services, such as seamless data access both indoors and outdoors, and AR/VR applications; URLLC is defined for applications that have stringent latency and reliability requirements, such as vehicular communications that can enable autonomous driving and control network in industrial plants; mMTC is the basis for connectivity in IoT, which allows for infrastructure management, environmental monitoring, and healthcare applications.

The overall protocol stack architecture for the NR system might be similar to that of the LTE/LTE-A system, but some functionalities of the protocol stacks of the LTE/LTE-A system should be modified in the NR system in order to resolve the weakness or drawback of LTE. RAN WG2 for NR is in charge of the radio interface architecture and protocols. The new functionalities of the control plane include the following: on-demand system information delivery to reduce energy consumption and mitigate interference, two-level (i.e. Radio Resource Control (RRC) and Medium Access Control (MAC)) mobility to implement seamless handover, beam based mobility management to accommodate high frequency, RRC inactive state to reduce state transition latency and improve UE battery life. The new functionalities of the user plane aim at latency reduction by optimizing existing functionalities, such as concatenation and reordering relocation, and RLC out of order delivery. In addition, a new user plane AS protocol layer named as Service Data Adaptation Protocol (SDAP) has been introduced to handle flow-based Quality of Service (QoS) framework in RAN, such as mapping between QoS flow and a data radio bearer, and QoS flow ID marking. Hereinafter the layer 2 according to the current agreements for NR is briefly discussed.

The layer 2 of NR is split into the following sublayers: Medium Access Control (MAC), Radio Link Control (RLC), Packet Data Convergence Protocol (PDCP) and Service Data Adaptation Protocol (SDAP). The physical layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers, and the SDAP sublayer offers to 5GC QoS flows. Radio bearers are categorized into two groups: data radio bearers (DRB) for user plane data and signalling radio bearers (SRB) for control plane data.

The main services and functions of the MAC sublayer of NR include: mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per carrier in case of carrier aggregation); priority handling between UEs by means of dynamic scheduling; priority handling between logical channels of one UE by means of logical channel prioritization; and padding. A single MAC entity can support one or multiple numerologies and/or transmission timings and mapping restrictions in logical channel prioritisation controls which numerology and/or transmission timing a logical channel can use.

The RLC sublayer of NR supports three transmission modes: Transparent Mode (TM); Unacknowledged Mode (UM); Acknowledged Mode (AM). The RLC configuration is per logical channel with no dependency on numerologies and/or TTI durations, and ARQ can operate on any of the numerologies and/or TTI durations the logical channel is configured with. For SRBO, paging and broadcast system information, TM mode is used. For other SRBs AM mode used. For DRBs, either UM or AM mode are used. The main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; Reassembly of SDU (AM and UM); duplicate detection (AM only); RLC SDU discard (AM and UM); RLC re-establishment; and protocol error detection (AM only). The ARQ within the RLC sublayer of NR has the following characteristics: ARQ retransmits RLC PDUs or RLC PDU segments based on RLC status reports; polling for RLC status report is used when needed by RLC; and RLC receiver can also trigger RLC status report after detecting a missing RLC PDU or RLC PDU segment.

The main services and functions of the PDCP sublayer of NR for the user plane include: sequence numbering; header compression and decompression: ROHC only; transfer of user data; reordering and duplicate detection; PDCP PDU routing (in case of split bearers); retransmission of PDCP SDUs; ciphering, deciphering and integrity protection; PDCP SDU discard; PDCP re-establishment and data recovery for RLC AM; and duplication of PDCP PDUs. The main services and functions of the PDCP sublayer of NR for the control plane include: sequence numbering; ciphering, deciphering and integrity protection; transfer of control plane data; reordering and duplicate detection; and duplication of PDCP PDUs.

The main services and functions of SDAP include: mapping between a QoS flow and a data radio bearer; marking QoS flow ID (QFI) in both DL and UL packets. A single protocol entity of SDAP is configured for each individual PDU session. Compared to LTE's QoS framework, which is bearer-based, the 5G system adopts the QoS flow-based framework. The QoS flow-based framework enables flexible mapping of QoS flow to DRB by decoupling QoS flow and the radio bearer, allowing more flexible QoS characteristic configuration.

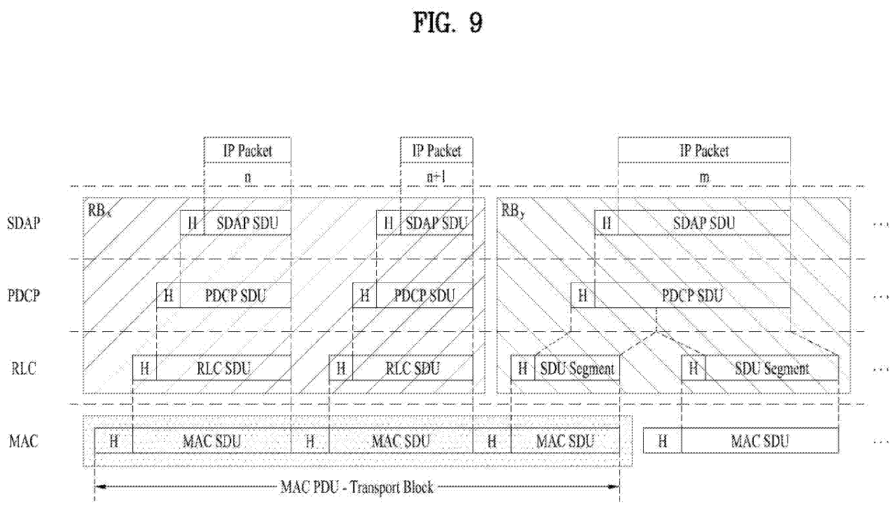

FIG. 9 illustrates a data flow example at a transmitting device in the NR system.

In FIG. 9, an RB denotes a radio bearer. Referring to FIG. 9, a transport block is generated by MAC by concatenating two RLC PDUs from RBₓ and one RLC PDU from RB_{y}. The two RLC PDUs from RBₓ each corresponds to one IP packet (n and n+1) while the RLC PDU from RB_{y} is a segment of an IP packet (m). In NR, a RLC SDU segment can be located in the beginning part of a MAC PDU and/or in the ending part of the MAC PDU.

In NR, segmentation is always enabled for RLC-AM and RLC-UM. A RLC SDU for UM and AM can be associated with only one RLC SN, i.e., the byte segments from a RLC SDU can be associated with the same RLC SN. Segmentation and re-segmentation is based on RLC SDU, i.e., SO field indicates byte position of the RLC SDU. RLC status report format is byte-aligned. In view of these characteristics of NR, NR may need different handling to reassemble RLC SDU from RLC SDU segments and generate STATUS PDU for RLC AM.

In LTE, a STATUS PDU can indicate each missed PDU or segmented PDU with their NACK_SN. The missing RLC PDU segment can be indicated by a set of NACK_SN, E1, E2, SOstart, and SOend in the STATUS PDU. In LTE, the extension bit 1 (E1) field of a RLC STATUS PDU is used to indicate whether or not a set of NACK_SN, E1 and extension bit 2 (E2) follows. This implies that the STATUS PDU of LTE needs to include every NACK_SN for each missing RLC PDU segment even though all missing AMD PDU segments come from a same AMD PDU. This means that same NACK_SN should be included multiple times to indicate each missing AMD PDU segment but actually this is unnecessary radio resource consumption. In LTE, segmentation for an RLC PDU is enabled only for RLC-AM and may occur when retransmitting an AMD PDU. Accordingly, the probability that the RLC PDU segmentation occurs is low in LTE, and the probability that a STATUS PDU contains an SN of an AMD PDU segment is low in LTE. In NR, segmentation is based on a RLC SDU and all RLC SDU segments from a RLC SDU should have same SN. Therefore, missing RLC SDU segments from one RLC SDU has the same SN. However, in NR, segmentation in the RLC layer is always enabled for RLC-AM and RLC-UM, and can occur for initial and retransmission. In other words, segmentation of NR is likely to occur more often than that of LTE. For this reason, if STATUS PDU as in LTE is used for this missing RLC SDU segments, the STATUS PDU needs to include NACK_SN for each missing RLC SDU segment, even though each missing RLC SDU segment from one RLC SDU has the same SN. If a number of missing RLC SDU segments of the RLC SDU is a lot, it will consume many bits for NACK_SN unnecessarily. To reduce the overhead of a STAUTS PDU in NR, the present invention proposes that a new format of STATUS PDU for RLC SDU segments be considered to include only one NACK_SN for multiple missing RLC SDU segments from the RLC SDU.

Another problem of the current definition for E1 field is that E1 can be zero only if no more set of NACK_SN, E1 and E2 follows, i.e., zero of E1 can exist only once to indicate end of RLC STATUS PDU with start of padding. This is huge restriction for E1=0 because end of RLC STATUS PDU can be indicated by any other way. In addition, in NR, it has been agreed that “NACK SN range” in the status report format is introduced. The NACK SN range field indicating the number of consecutively lost RLC SNs starting from and including NACK_SN. If there are consecutively lost RLC SDUs with missing RLC SDU segments, it would need very complicated structure to describe a missing RLC SDU and RLC SDU segments together on a STATUS PDU. To reduce complexity of a RLC STATUS PDU format, E1 is redefined in the present invention. If E1 field is redefined as in the present invention, zero of E1 can exist multiple times in the RLC STATUS PDU and this will not only provide more flexibility to the structure of the RLC STATUS PDU but also decrease unnecessary radio resource consumption because zero of E1 can be used to indicate whether extended field exists or not. In NR, even more gains are expected by redefinition of E1 field because the extension bit 3 (E3) field for NACK_SN range is added in RLC STATUS PDU.

To avoid the above-mentioned problems, a new STATUS PDU format and a redefinition of E1 field are proposed in the present invention. In the present invention, the new STATUS PDU format may indicate multiple missing RLC SDU segments of a RLC SDU more appropriately compared to that of LTE. Hereinafter, for convenience of description, a set of fields used for indicating multiple missing RLC SDU segments of a RLC SDU is referred to as “SEG_STATUS PDU.”

In the present invention, RLC PDU contains a RLC header indicating if RLC PDU carries a complete RLC SDU or RLC SDU segments. The RLC header does not include SO field if RLC PDU carries a complete RLC SDU. The RLC header does not include SO field when the beginning of the RLC SDU is segmented. The RLC header includes SO field when the middle or end of the RLC SDU is segmented. The RLC header indicates whether the RLC PDU contains the end part of RLC SDU segment or not when the middle or end of the RLC SDU is segmented. A receiving RLC entity of the present invention receives RLC PDU(s) from lower layer(s), and may detect whether there are missing RLC SDU(s) and/or missing RLC SDU segment(s).

In the present invention, the receiving AM RLC entity may be located in UE, eNB, gNB, or other wireless network/devices. In the present invention, the transmitting AM RLC entity may be located in UE, eNB, gNB, or other wireless network/devices

In the present invention, if one or more missing RLC SDU segments of a RLC SDU are detected, the receiving AM RLC entity constructs a SEG_STATUS PDU which indicates multiple missing RLC SDU segments of the RLC SDU, and transmits the constructed SEG_STATUS PDU to the peer transmitting AM RLC entity to request retransmission of the multiple missing RLC SDU segments of the RLC SDU.

When an receiving AM RLC entity receives a RLC SDU segment, which is the first received segment belonging to a RLC SDU, the receiving AM RLC entity starts a reassembly timer for the RLC SDU to which the received RLC SDU segment belongs. When the reassembly timer for the RLC SDU expires, if not all segments of the RLC SDU are received to be reassembled, the receiving AM RLC entity:

>detects a missing RLC SDU segment; and/or

>triggers SEG_STATUS PDU; and/or

>restarts the reassembly timer for the RLC SDU.

When the receiving AM RLC entity receives a retransmitted RLC SDU segment after triggering SEG_STATUS PDU, which is the first retransmitted segment belonging to the RLC SDU, the receiving AM RLC entity restarts the reassembly timer for the RLC SDU. If SEG_STATUS PDU is triggered, the receiving RLC entity generates a SEG_STATUS PDU for the RLC SDU. A STATUS PDU containing the SEG_STATUS PDU may include the followings:
Sequence Number of the RLC SDU to which a missing RLC SDU segment belongs;
The start offset and the last offset of a missing RLC SDU segment belonging to the RLC SDU;
One bit indicator to indicate whether the RLC PDU is RLC data PDU or RLC control PDU;
Three bits indicator to indicate the type of the RLC control PDU;
The extension bit 1 field to indicate whether or not a set of start offset field, end offset field and extension bit 1 field follows.

If there are multiple RLC SDUs for which the receiving RLC entity detects missing RLC SDU segments, the receiving RLC entity generates a SEG_STATUS PDU for each of the multiple RLC SDUs. In other words, in the present invention, a STATUS PDU may contain multiple SEG_STATUS PDUs if the receiving RLC entity detects multiple RLC SDU segments belonging to different RLC SDUs.

If the receiving AM RLC entity generates a SEG_STATUS PDU for a RLC SDU, the receiving AM RLC entity sends the generated the SEG_STATUS PDU for the RLC SDU to the peer transmitting AM RLC entity.

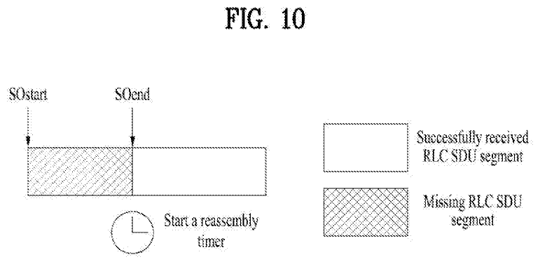

FIG. 10 illustrates an example of starting a reassembly timer for the radio link control (RLC) service data unit (SDU) to which a received RLC SDU segment belongs.

In the example shown in FIG. 10, a reassembly timer is started when a receiving RLC entity receives a RLC SDU segment which is the first received segment belonging to the RLC SDU.

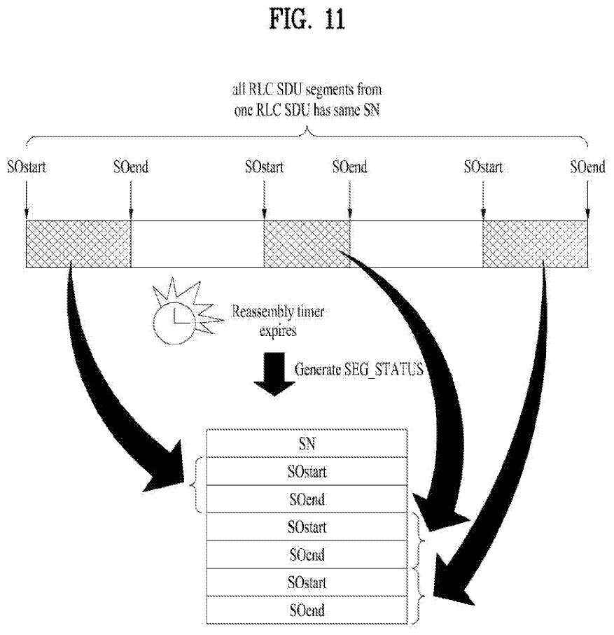

FIG. 11 illustrates an example of generating a SEG_STATUS PDU of the present invention.

When the reassembly timer for the RLC SDU expires, the receiving AM RLC entity detects missing RLC SDU segments and triggers SEG_STATUS PDU because not all segments of the RLC SDU are received. When the receiving AM RLC entity generates SEG_STATUS PDU, firstly SN of the RLC SDU is included, and then start offset and last offset of each missing RLC SDU segment of the RLC SDU are included sequentially. As shown in FIG. 11, in the present invention, a SEG_STATUS PDU for a RLC SDU includes an SN field indicating the SN of the RLC SDU, a start offset (SO start) field and a last offset for each missing RLC SDU segment of the RLC SDU. In the present invention, a NACK_SN for a RLC SDU is included only once in a SEG_STATUS PDU even if the receiving RLC entity detects multiple missing RLC SDU segments belonging to the RLC SDU. Therefore, the present invention can reduce the number of NACK_SN fields in a STATUS PDU, thereby reducing the required bytes to describe same missing information compared to a STATUS PDU format in LTE.

If the SEG_STATUS PDU is generated, the receiving AM RLC entity transmits the generated SEG_STATUS PDU to the peer transmitting AM RLC entity.

The receiving AM RLC entity maintains a discard timer for a RLC SDU to determine whether the receiving AM RLC entity discards the received RLC SDU segments belonging to the RLC SDU. The receiving AM RLC entity starts the discard timer for the RLC SDU when the receiving AM RLC entity receives a RLC SDU segment which is the first received segment belonging to the RLC SDU, or when the receiving AM RLC entity receives an retransmitted RLC SDU segment which is the first retransmitted segment belonging to the RLC SDU after the reassembly timer for the RLC SDU is expired for the first time. The discard timer for the RLC SDU is longer than the reassembly timer for the RLC SDU. When the discard timer expires, if not all segments of the RLC SDU are received to be reassembled, the receiving AM RLC entity may discard RLC SDU segments belonging to the RLC SDU.

Hereinafter, the more detailed RLC STATUS PDU format according to the present invention is described. In this contribution, we discuss on each field of RLC STATUS PDU and propose the RLC STATUS PDU format accordingly. The rest of the fields other than those proposed or redefined in the present invention can follow the format or definition of the LTE STATUS PDU.

In NR, it has been agreed that a new extension (E3) field is introduced for indicating the presence of NACK range. Several NACK range fields can be included in the RLC Status PDU. In the present invention, when a RLC STATUS PDU is generated, a receiving AM RLC entity appends multiple E1 fields with 0 to include multiple extended SOstart/SOend fields or NACK_SN range fields if missing RLC SDU segments from a RLC SDU or consecutively more than 64 missing RLC SDUs are detected, and transmits the constructed RLC STATUS PDU to the peer transmitting AM RLC entity to request retransmission of the multiple missing RLC SDU segments of the RLC SDU or consecutively missing RLC SDUs. When the received RLC STATUS PDU is interpreted, the peer transmitting AM RLC entity identifies missing RLC SDU segments from a RLC SDU using extended SOstart/SOend fields which is associated with the NACK_SN field indicated by the latest E1 field with 1 or consecutively more than 64 missing RLC SDUs using extended NACK_SN range field which is associated with the NACK_SN field indicated by the latest E1 field with 1, and retransmits all missing RLC SDU segments or all missing RLC SDUs, which are recognized by the received RLC STATUS PDU, to the peer receiving AM RLC entity.

In the present invention, the RLC STATUS PDU may include the following fields:
One bit indicator (D/C) field to indicate whether the RLC PDU is RLC data PDU or RLC control PDU;
Three bits indicator (CPT) field to indicate the type of the RLC control PDU;
Acknowledged Sequence Number of the RLC SDU (ACK_SN) field to indicate the SN of the next not received RLC SDU which is not reported as missing in the RLC STATUS PDU;
Negative Acknowledged Sequence Number of the RLC SDU (NACK_SN) field to indicate the SN of the RLC SDU (or portions of it) that has been detected as lost at the receiving side of the AM RLC entity;
The start offset (SOstart) and the last offset (SOend) field of a missing RLC SDU segment belonging to the RLC SDU;
The extended SOstart and SOend field to indicate a missing RLC SDU segment belonging to the latest RLC SDU;
The missing RLC SDU range (NACK_SN range) field to indicate how many RLC SDUs are missed consecutively;
The extended NACK_SN range field to indicate how many RLC SDUs are missed consecutively from the latest NACK_SN range field;
The E1 field indicates whether or not NACK_SN field follows after E3 field;
The E2 field indicates whether or not SOstart and SOend fields follow after the E3 field or the NACK_SN field;
The E3 field indicates whether or not NACK_SN range field follows after the E3 field or the SOend field;
Padding bits to be byte aligned.

If there is an RLC SDU having a missed RLC SDU segment in the middle of consecutively missed RLC SDUs, the number of consecutively missed RLC SDUs before the RLC SDU having the missed RLC SDU segment is indicated by a NACK_SN range and the number of consecutively missed RLC SDUs after the RLC SDU having the missed RLC SDU segment is indicated by another NACK_SN range.

When a receiving AM RLC entity receives an AMD PDU with Poll bit=1 and the prohibit timer is not running, the receiving AM RLC entity triggers a RLC STATUS PDU.

When the reassembly timer expires, if a missing RLC SDU or missing RLC SDU segment is detected, the receiving AM RLC entity triggers a RLC STATUS PDU.

When a RLC STATUS PDU is triggered, the receiving AM RLC entity checks the reception buffer and may construct a RLC STATUS PDU according to the following rule:
For a complete missing RLC SDU, the receiving AM RLC entity appends E1=1, E2=0 and E3=0 and the NACK_SN field sequentially;
For a missing RLC SDU segment, the receiving AM RLC entity appends E1=1, E2=1, E3=0, the NACK_SN field, and SOstart/SOend fields sequentially;
For another missing RLC SDU segment which is belonging to the latest NACK_SN field, the receiving AM RLC entity does not append the NACK_SN field and append E1=0, E2=1, E3=0, and an extended SOstart/SOend field sequentially;
For consecutively missing RLC SDUs which total count is larger than the amount of the NACK_SN range field, the receiving AM RLC entity appends E1=1, E2=0, E3=1, the NACK_SN field, and the NACK_SN range field sequentially;
For consecutively missing RLC SDUs which total count is larger than the amount of the NACK_SN range field, the receiving AM RLC entity appends E1=1, E2=0,E3=1, the NACK_SN field, and the NACK_SN range field sequentially first. And then the receiving AM RLC entity does not append the NACK_SN field and append E1=0, E2=0, E3=1, and an extended NACK_SN range field sequentially and does this operation to add an extended NACK_SN range field repeatedly until all combined NACK_SN range fields cover all consecutively missing RLC SDUs;
For consecutively missing RLC SDUs with two missing RLC SDU segments which one is placed at the beginning and another is placed at the end, the receiving AM RLC entity appends E1=1, E2=1, E3=1, the NACK_SN field, SOstart/SOend fields, and the NACK_SN range field sequentially;
For consecutively missing RLC SDUs, which total count is larger than the amount of the NACK_SN range field, with two missing RLC SDU segments which one is placed at the beginning and another is placed at the end, the receiving AM RLC entity appends E1=1, E2=1, E3=1, the NACK_SN field, SOstart/SOend fields, and the NACK_SN range field sequentially first. And then the receiving AM RLC entity does not append the NACK_SN field and append E1=0, E2=0, E3=1, and an extended NACK_SN range field sequentially and does this operation to add an extended NACK_SN range field repeatedly until all combined NACK_SN range fields cover all consecutively missing RLC SDUs;
For no more missing RLC SDU and RLC SDU segment, the receiving AM RLC entity appends E1=0, E2=0, E3=0, and padding bits, if needed, sequentially.

If the RLC STATUS PDU is successfully constructed, the receiving AM RLC entity transmits the constructed RLC STATUS PDU to the peer transmitting AM RLC entity to request retransmission of missing RLC SDUs and missing RLC SDU segments.

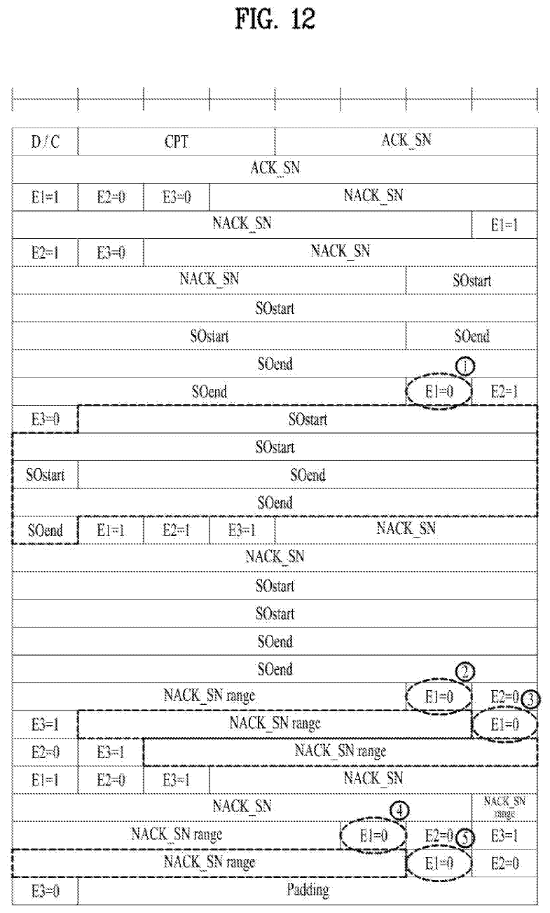

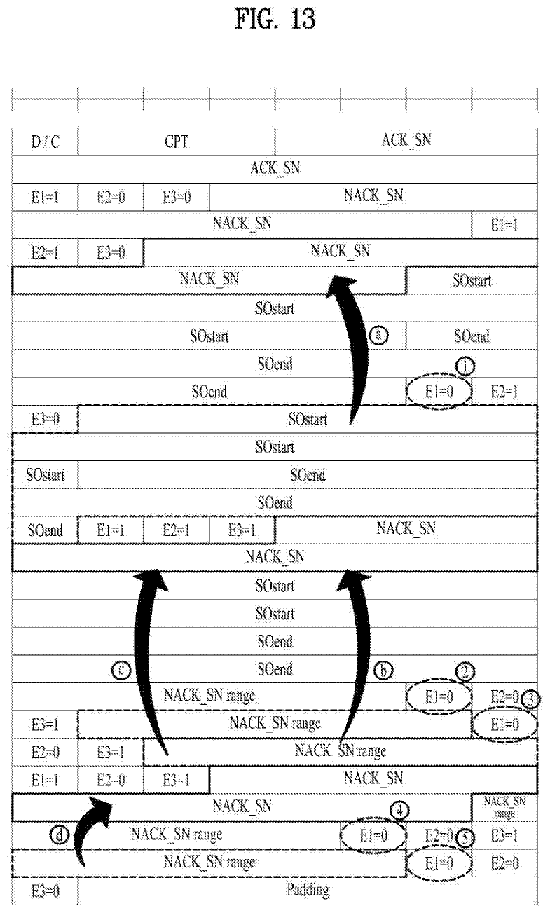

FIG. 12 and FIG. 13 illustrate an example of a STATUS PDU of the present invention in view of an RLC entity receiving RLC PDU(s) and an RLC entity transmitting RLC PDU(s), respectively. In the example of the STATUS PDU shown in FIG. 12 and FIG. 13, the following values are used:
E1, E2, and E3 fields: 1 bit for each field;
D/C field: 1 bit;
CPT field: 3 bits
ACK_SN field: 12 bits;
NACK_SN field: 12 bits;
NACK_SN range field: 6 bits;
SOstart and SOend field: 16 bits.

FIG. 12 shows an example of constructing an RLC STATUS PDU according to the present invention.

When the receiving AM RLC entity detects from the reception buffer that there is one complete missing RLC SDU, the receiving AM RLC entity appends a NACK_SN field with E1=1, E2=0, and E3=0 to indicate the missing RLC SDU.

When the receiving AM RLC entity detects from the reception buffer that there are two missing RLC SDU segments from an RLC SDU, the receiving AM RLC entity appends a NACK_SN field, SOstart/SOend fields with E1=1, E2=1, and E3=0 to indicate the first missing RLC SDU segment and, for the second missing RLC SDU segment, the receiving AM RLC entity does not append the NACK_SN field and append the only extended SOstart/SOend fields with E1=0, E2=1, and E3=0 as marked with \textcircled{1} in FIG. 12. SOstart/SOend fields of LTE always start with a NACK_SN field, whereas SOstart/SOend fields of the present invention may start with no NACK_SN field if other SOstart/SOend fields starting with a NACK_SN field for the same RLC SDU are already included in a corresponding RLC STATUS PDU.

There may be a MAC PDU which contains a RLC SDU segment (first RLC SDU segment) at the beginning portion of the MAC PDU, another RLC SDU segment (last RLC SDU segment) at the ending portion of the MAC PDU, and consecutive complete RLC SDUs between the first and last RLC SDU segments), and the whole MAC PDU may be lost. For example, referring to FIG. 12, when consecutively missing (complete) RLC SDUs with two missing RLC SDU segments, where one of the two missing RLC SDU segments is placed at the beginning portion of a MAC PDU and another one of the two missing RLC SDU segments is placed at the end portion of the MAC PDU, are detected from the reception buffer and the total number of consecutively missing RLC SDUs from a missing RLC SDU indicated by a NACK_SN field is 150, the receiving AM RLC entity appends a NACK_SN field, SOstart/SOend fields, and a NACK_SN range field with E1=1, E2=1, and E3=1 to indicate the two missing RLC SDU segments and the first 64 missing RLC SDUs starting from an RLC SDU of the NACK_SN field. In other words, when there are consecutively missing complete RLC SDUs with two missing RLC SDUs, where one of the two missing RLC SDUs (first missing RLC SDU segment) is the last portion of an RLC SDU with an SN right before an SN of the first RLC SDU among the consecutively missing complete RLC SDUs and the other one of the two missing RLC SDUs (last missing RLC SDU segment) is the starting portion of an RLC SDU with an SN right after an SN of the last RLC SDU among the consecutively missing complete RLC SDUs, the STATUS PDU includes E1=1, E2=1 and E3=1, and the NACK_SN field may follow after the E3 field and the SOstart field may follow after the NACK_SN field to indicate the start position of the first missing RLC SDU segment, and the SOend field follows after the SOstart field to indicate the end position of the last missing RLC SDU segment and the NACK_SN range field follows after the SOend field to indicate how many RLC SDUs are missed consecutively starting from the NACK_SN field including RLC SDUs of the first and the last missing RLC SDU segments. For E1=1, E2=1 and E3=1, the SOend field may indicate the end of the last missing RLC SDU in an RLC SDU with SN=SN of the NACK_SN field+the number of consecutively missing complete RLC SDUs+1 (i.e. the SOend field may indicate the end of the last missing RLC SDU in an RLC SDU with SN=SN of the NACK_SN field+the total number of consecutively missing RLC SDUs including the RLC SDUs of the first and last RLC SDU segments—1). For the consecutively missing RLC SDU from 65 to 128, the receiving AM RLC entity does not append the NACK_SN field and appends only extended NACK_SN range field with E1=0, E2=0, and E3=1 as marked with \textcircled{2} in FIG. 12. For the remaining consecutively missing RLC SDUs from 129 to 150, the receiving AM RLC entity does not append the NACK_SN field and appends another extended NACK_SN range field with E1=0, E2=0, and E3=1 as marked with \textcircled{3} in FIG. 12.

When consecutively missing RLC SDUs, which total count is 80, are detected from the reception buffer, the receiving AM RLC entity appends a NACK_SN field, and a NACK_SN range field with E1=1, E2=0, and E3=1 to indicate the first 64 missing RLC SDUs from the NACK_SN field. For the consecutively missing RLC SDUs from 65 to 80, the receiving AM RLC entity does not append the NACK_SN field and appends the extended NACK_SN range field with E1=0, E2=0, and E3=1 as marked with \textcircled{4} in FIG. 12.

When no more missing RLC SDU and RLC SDU segment are detected from the reception buffer, the receiving AM RLC entity appends E1=0, E2=0, E3=0 and padding bits, if needed, as marked with \textcircled{5} in FIG. 12.

When an RLC STATUS PDU is received, the transmitting AM RLC entity reads the received RLC STATUS PDU sequentially and may interpret each combination of extension bits according to the following rules:
For E1=1, E2=0 and E3=0, the transmitting AM RLC entity understands that the NACK_SN field follows after the E3 field to indicate the missing RLC SDU;
For E1=1, E2=1 and E3=0, the transmitting AM RLC entity understands that the NACK_SN field follows after the E3 field and SOstart/SOend fields follow after the NACK_SN field to indicate the position of the missing RLC SDU segment which is associated with the NACK_SN field;
For E1=0, E2=1 and E3=0, the transmitting AM RLC entity understands that SOstart/SOend fields follow after the E3 field and the missing RLC SDU segment is associated with the latest NACK_SN field;
For E1=1, E2=0 and E3=1, the transmitting AM RLC entity understands that the NACK_SN field follows after the E3 field and a NACK_SN range field follows after the NACK_SN field to indicate how many RLC SDUs are missed consecutively from the NACK_SN field;
For E1=1, E2=1 and E3=1, the transmitting AM RLC entity understands that the NACK_SN field follows after the E3 field and the SOstart field follows after the NACK_SN field to indicate the start position of the first missing RLC SDU segment and the SOend field follows after the SOstart field to indicate the end position of the last missing RLC SDU segment and the NACK_SN range field follows after the SOend field to indicate how many RLC SDUs are missed consecutively from the NACK_SN field;
For E1=0, E2=0 and E3=1, the transmitting AM RLC entity understands that the NACK_SN range field follows after the E3 field to indicate how many RLC SDUs are missed consecutively from end of the latest NACK_SN range field and the NACK_SN range field is associated with the latest NACK_SN field;
For E1=0, E2=0 and E3=0, the transmitting AM RLC entity understands that here is the end of the RLC STATUS PDU and maybe padding bits follows after the E3 field because of byte alignment.

When the received RLC STATUS PDU is interpreted successfully, the transmitting AM RLC entity can identify all missing RLC SDUs and all missing RLC SDU segments and retransmit all missing RLC SDUs and all missing RLC SDU segments to the peer receiving AM RLC entity.

FIG. 13 shows an example of interpreting an RLC STATUS PDU according to the present invention.

When E1=1, E2=0, and E3=0 are detected, the NACK_SN field follows after E3 field to indicate the SN of the missing RLC SDU.

When E1=1, E2=1, and E3=0 are detected, the NACK_SN field follows after E3 field to indicate the SN of the missing RLC SDU segment and SOstart/SOend fields follow after the NACK_SN field to indicate the position of the missing RLC SDU segment within an RLC SDU which is associated with the NACK_SN field.

When E1=0, E2=1, and E3=0 are detected, SOstart/SOend fields follow after E3 field to indicate the position of the missing RLC SDU segment within an RLC SDU which is associated with the latest NACK_SN field as shown by an arrow marked with \textcircled{a} in FIG. 13.

When E1=1, E2=1, and E3=1 are detected and the total number of consecutively missing RLC SDUs from a NACK_SN field is 150 as the same in the example of FIG. 12, the NACK_SN field follows after E3 field to indicate the SN of the first missing RLC SDU segment and the SOstart field follows after the NACK_SN field to indicate the start position of the first missing RLC SDU segment and the SOend field follows after the SOstart field to indicate the end position of the last missing RLC SDU segment and the NACK_SN range field follows after the SOend field to indicate 64 consecutively missing RLC SDUs starting from an RLC SDU of the NACK_SN field to an RLC SDU with ‘SN of the NACK_SN field+63’. When E1=0, E2=0, and E3=1 are detected, the NACK_SN range field follows after E3 field to indicate 64 consecutively missing RLC SDUs from an RLC SDU with ‘SN of the NACK_SN field +64’ to an RLC SDU ‘SN of the NACK_SN field+127’, where the NACK_SN field is the latest NACK_SN field as shown by an arrow marked with \textcircled{b} in FIG. 13.

When E1=0, E2=0, and E3=1 are detected, the NACK_SN range field follows after E3 field to indicate consecutively missing RLC SDUs from an RLC SDU with ‘SN of the NACK_SN field+128’ to an RLC SDU with ‘SN of the NACK_SN field+149’, where the NACK_SN field is the latest NACK_SN field as shown by an arrow marked with \textcircled{c} in FIG. 13.

When E1=1, E2=0, and E3=1 are detected and the total number of consecutively missing RLC SDUs from a NACK_SN field is 80 as the same in the example of FIG. 12, the NACK_SN field follows after E3 field to indicate the SN of the first missing RLC SDU and the NACK_SN range field follows after the NACK_SN field to indicate consecutively missing RLC SDUs from an RLC SDU of the NACK_SN field to an RLC SDU ‘SN of the NACK_SN field+63’.

When E1=0, E2=0, and E3=1 are detected, the NACK_SN range field follows after E3 field to indicate consecutively missing RLC SDUs from an RLC SDU ‘SN of the NACK_SN field +64’ to an RLC SDU ‘SN of the NACK_SN field+79’, where the NACK_SN field is the latest NACK_SN field as shown by an arrow marked with \textcircled{d} in FIG. 13.

When E1=0, E2=0, and E3=0 are detected, here is the end of the STATUS PDU and padding bits follows after the E3 field if byte alignment is needed as marked with \textcircled{5}.

After above interpretation, the transmitting AM RLC entity can identify all missing RLC SDUs and all missing RLC SDU segments and retransmit all missing RLC SDUs and all missing RLC SDU segments to the peer receiving AM RLC entity.

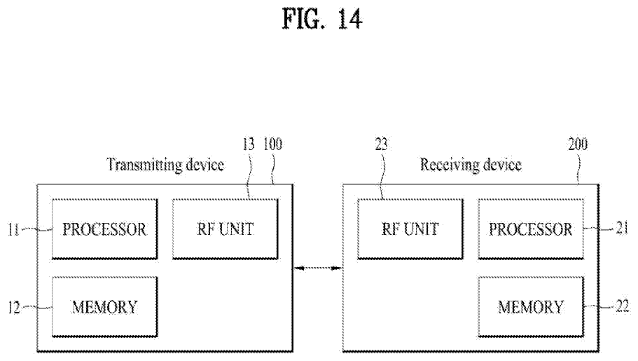

FIG. 14 is a block diagram illustrating elements of a transmitting device 100 and a receiving device 200 for implementing the present invention.

The transmitting device 100 and the receiving device 200 respectively include Radio Frequency (RF) units 13 and 23 capable of transmitting and receiving radio signals carrying information, data, signals, and/or messages, memories 12 and 22 for storing information related to communication in a wireless communication system, and processors 11 and 21 operationally connected to elements such as the RF units 13 and 23 and the memories 12 and 22 to control the elements and configured to control the memories 12 and 22 and/or the RF units 13 and 23 so that a corresponding device may perform at least one of the above-described embodiments of the present invention.

The memories 12 and 22 may store programs for processing and controlling the processors 11 and 21 and may temporarily store input/output information. The memories 12 and 22 may be used as buffers.

The processors 11 and 21 generally control the overall operation of various modules in the transmitting device and the receiving device. Especially, the processors 11 and 21 may perform various control functions to implement the present invention. The processors 11 and 21 may be referred to as controllers, microcontrollers, microprocessors, or microcomputers. The processors 11 and 21 may be implemented by hardware, firmware, software, or a combination thereof. In a hardware configuration, application specific integrated circuits (ASICs), digital signal processors (DSPs), digital signal processing devices (DSPDs), programmable logic devices (PLDs), or field programmable gate arrays (FPGAs) may be included in the processors 11 and 21. Meanwhile, if the present invention is implemented using firmware or software, the firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 100 performs predetermined coding and modulation for a signal and/or data scheduled to be transmitted to the outside by the processor 11 or a scheduler connected with the processor 11, and then transfers the coded and modulated data to the RF unit 13. For example, the processor 11 converts a data stream to be transmitted into K layers through demultiplexing, channel coding, scrambling, and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nₜ (where Nₜ is a positive integer) transmit antennas.

A signal processing process of the receiving device 200 is the reverse of the signal processing process of the transmitting device 100. Under control of the processor 21, the RF unit 23 of the receiving device 200 receives radio signals transmitted by the transmitting device 100. The RF unit 23 may include Nᵣ (where Nᵣ is a positive integer) receive antennas and frequency down-converts each signal received through receive antennas into a baseband signal. The processor 21 decodes and demodulates the radio signals received through the receive antennas and restores data that the transmitting device 100 intended to transmit.

The RF units 13 and 23 include one or more antennas. An antenna performs a function for transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. The signal transmitted from each antenna cannot be further deconstructed by the receiving device 200. An RS transmitted through a corresponding antenna defines an antenna from the view point of the receiving device 200 and enables the receiving device 200 to derive channel estimation for the antenna, irrespective of whether the channel represents a single radio channel from one physical antenna or a composite channel from a plurality of physical antenna elements including the antenna. That is, an antenna is defined such that a channel carrying a symbol of the antenna can be obtained from a channel carrying another symbol of the same antenna. An RF unit supporting a MIMO function of transmitting and receiving data using a plurality of antennas may be connected to two or more antennas. The RF units 13 and 23 may be referred to as transceivers.

In the embodiments of the present invention, a UE operates as the transmitting device 100 in UL and as the receiving device 200 in DL. In the embodiments of the present invention, a gNB operates as the receiving device 200 in UL and as the transmitting device 100 in DL. Hereinafter, a processor, a transceiver, and a memory included in the UE will be referred to as a UE processor, a UE transceiver, and a UE memory, respectively, and a processor, a transceiver, and a memory included in the gNB will be referred to as a gNB processor, a gNB transceiver, and a gNB memory, respectively.

The UE processor can be configured to operate according to the present invention, or control the UE transceiver to receive or transmit signals according to the present invention. The gNB processor can be configured to operate according to the present invention, or control the gNB transceiver to receive or transmit signals according to the present invention.

A processor 21 of a receiving device 200 is configured to detect missing RLC SDU(s) and/or missing RLC SDU segment(s). The processor 21 is configured to generate a STATUS PDU, for informing a transmitting device 100 of the missing RLC SDU(s) and/or missing RLC SDU segment(s), according to the present invention. If there are missing multiple RLC SDU segments of an RLC SDU, the processor 21 generates the STATUS PDU to contain one sequence number (SN) for the multiple missing RLC SDU segments, which is the same as a SN of the RLC SDU. The processor 21 generates the STATUS PDU to contain location information on each of the multiple missing RLC SDU segments within the RLC SDU. The processor 21 controls a transceiver 23 of the processor 21 to transmit the STATUS SDU to the transmitting device 100. The processor 21 may start a reassembly timer for the RLC SDU if an RLC SDU segment of the RLC SDU is first received at the RLC entity, and the STATUS PDU if the reassembly timer expires.

A transceiver 13 of the transmitting device 100 receives the STATUS PDU. A processor 11 of the transmitting device 100 is configured to control the transceiver 13 to transmit an RLC SDU or RLC SDU segment indicated by the STATUS PDU. If there are missing multiple RLC SDU segments of an RLC SDU, the STATUS PDU includes one NACK_SN field for the multiple RLC SDUs of the RLC SDU and the processor 11 controls the transceiver 13 to transmit the multiple RLC SDUs.

The location information is a start offset (SOstart) and an end offset (SOend) of each missing RLC SDU segment of the RLC SDU.

The STATUS PDU contains a first indicator (E1) field, a second indicator (E2) field and a third indicator (E3) field. The E1 field indicates whether or not a SN (NACK_SN) for a missing RLC SDU or missing RLC SDU segment follows after the E3 field. If the E1 field indicates that a NACK_SN does not follow after the E3 field, fields after the E3 field are associated with a latest SN before the E1 field.

The E2 field indicates whether or not a set of SOstart and SOend follow after the E3 field or a NACK_SN. The E3 field indicates whether or not a NACK_SN range follows after the E3 field or a SOend associated with a NACK_SN indicated by a latest E1 field. If the E1 field indicates that a NACK_SN does not follow after the E3 field, if the E2 field indicates that a set of SOstart and SOend does not follow after the E3 field, and if the E3 field indicates that a NACK_SN range field follows after the E3 field, a field after the E3 field indicates a number of consecutive NACK_SNs next to a SN of a last missing RLC SDU or RLC SDU segment indicate by a latest NACK_SN or NACK_SN range before the E1, E2 and E3 fields. If the E1 field indicates that a NACK_SN does not follow after the E3 field, if the E2 field indicates that a set of SOstart and SOend does not follow after the E3 field, and if the E3 field indicates that a NACK_SN range field does not follow after the E3 field, the E1, E2 and E3 fields indicate the end of the STATUS PDU.

As described above, the detailed description of the preferred embodiments of the present invention has been given to enable those skilled in the art to implement and practice the invention. Although the invention has been described with reference to exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

The embodiments of the present invention are applicable to a network node (e.g., BS), a UE, or other devices in a wireless communication system.

What is claimed is:

1. A method for receiving a data unit by a receiving device in a wireless communication system, the method comprising:
detecting that multiple radio link control (RLC) service data unit (SDU) segments of an RLC SDU are missing;
generating, at an RLC entity of the receiving device, a status protocol data unit (PDU) for the multiple missing RLC SDU segments; and
transmitting the status PDU to a transmitting side,
wherein the status PDU contains one sequence number (SN) for the multiple missing RLC SDU segments, which is the same as a SN of the RLC SDU, and location information on each of the multiple missing RLC SDU segments within the RLC SDU.

2. The method according to claim 1,
wherein the location information is a start offset (SOstart) and an end offset (SOend) of each missing RLC SDU segment of the RLC SDU.

3. The method according to claim 1,
wherein the status PDU contains a first indicator (E1) field, a second indicator (E2) field and a third indicator (E3) field, and
wherein the E1 field indicates whether or not a SN (NACK_SN) for a missing RLC SDU or missing RLC SDU segment follows after the E3 field.

4. The method according to claim 3,
wherein, if the E1 field indicates that a NACK_SN does not follow after the E3 field, fields after the E3 field are associated with a latest SN before the E1 field.

5. The method according to claim 4,
wherein the E2 field indicates whether or not a set of SOstart and SOend follow after the E3 field or a NACK_SN,
wherein the E3 field indicates whether or not a NACK_SN range follows after the E3 field or a SOend associated with a NACK_SN indicated by a latest E1 field,
wherein, if the E1 field indicates that a NACK_SN does not follow after the E3 field, if the E2 field indicates that a set of SOstart and SOend does not follow after the E3 field, and if the E3 field indicates that a SN range field follows after the E3 field, a field after the E3 field indicates a number of consecutive NACK_SNs next to a SN of a last missing RLC SDU or RLC SDU segment indicate by a latest NACK_SN or NACK_SN range before the E1, E2 and E3 fields.

6. The method according to claim 4,
wherein the E2 field indicates whether or not a set of SOstart and SOend follow after the E3 field or a NACK_SN,
wherein the E3 field indicates whether or not a NACK_SN range field follows after the E3 field or a SOend associated with a NACK_SN indicated by a latest E1 field,
wherein, if the E1 field indicates that a NACK_SN does not follow after the E3 field, if the E2 field indicates that a set of SOstart and SOend does not follow after the E3 field, and if the E3 field indicates that a NACK_SN range field does not follow after the E3 field, the E1, E2 and E3 fields indicate the end of the status PDU.

7. The method according to claim 1, further comprising:
starting a reassembly timer for the RLC SDU if an RLC SDU segment of the RLC SDU is first received at the RLC entity; and
generating the status PDU if the reassembly timer expires.

8. A method for transmitting a data unit by a transmitting device in a wireless communication system, the method comprising:
receiving a status PDU; and
transmitting a radio link control (RLC) service data unit (SDU) or RLC SDU segment indicated by the status PDU,
wherein the status PDU contains one sequence number (SN) for the multiple missing RLC SDU segments, which is the same as a SN of the RLC SDU, and location information on each of the multiple missing RLC SDU segments within the RLC SDU.

9. The method according to claim 8,
wherein the status PDU contains a first indicator (E1) field, a second indicator (E2) field and a third indicator (E3) field, and
wherein the E1 field indicates whether or not a SN (NACK_SN) for a missing RLC SDU or missing RLC SDU segment follows after the E3 field.

10. The method according to claim 9,
wherein, if the E1 field indicates that a NACK_SN does not follow after the E3 field, fields after the E3 field are associated with a latest SN before the E1 field.

11. A receiving device for receiving a data unit in a wireless communication system, the receiving device comprising:
a transceiver, and
a processor configured to control the transceiver, the processor configured to:
detect that multiple radio link control (RLC) service data unit (SDU) segments of an RLC SDU are missing;
generate, at an RLC entity of the receiving device, a status protocol data unit (PDU) for the multiple missing RLC SDU segments; and
control the transceiver to transmit the status PDU to a transmitting side,
wherein the status PDU contains one sequence number (SN) for the multiple missing RLC SDU segments, which is the same as a SN of the RLC SDU, and location information on each of the multiple missing RLC SDU segments within the RLC SDU.

12. The receiving device according to claim 11,
wherein the location information is a start offset (SOstart) and an end offset (SOend) of each missing RLC SDU segment of the RLC SDU.

13. The receiving device according to claim 11,
wherein the status PDU contains a first indicator (E1) field, a second indicator (E2) field and a third indicator (E3) field, and
wherein the E1 field indicates whether or not a SN (NACK_SN) for a missing RLC SDU or missing RLC SDU segment follows after the E3 field.

14. The receiving device according to claim 13,
wherein, if the E1 field indicates that a NACK_SN does not follow after the E3 field, fields after the E3 field are associated with a latest SN before the E1 field.

15. The receiving device according to claim 14,
wherein the E2 field indicates whether or not a set of SOstart and SOend follow after the E3 field or a NACK_SN,
wherein the E3 field indicates whether or not a NACK_SN range follows after the E3 field or a SOend associated with a NACK_SN indicated by a latest E1 field,
wherein, if the E1 field indicates that a NACK_SN does not follow after the E3 field, if the E2 field indicates that a set of SOstart and SOend does not follow after the E3 field, and if the E3 field indicates that a NACK_SN range field follows after the E3 field, a field after the E3 field indicates a number of consecutive NACK_SNs next to a SN of a last missing RLC SDU or RLC SDU segment indicate by a latest NACK_SN or NACK_SN range before the E1, E2 and E3 fields.

16. The receiving device according to claim 14,
wherein the E2 field indicates whether or not a set of SOstart and SOend follow after the E3 field or a NACK_SN,
wherein the E3 field indicates whether or not a NACK_SN range field follows after the E3 field or a SOend associated with a NACK_SN indicated by a latest E1 field,
wherein, if the E1 field indicates that a NACK_SN does not follow after the E3 field, if the E2 field indicates that a set of SOstart and SOend does not follow after the E3 field, and if the E3 field indicates that a NACK_SN range field does not follow after the E3 field, the E1, E2 and E3 fields indicate the end of the status PDU.

17. The receiving device according to claim 11, further comprising:
starting a reassembly timer for the RLC SDU if an RLC SDU segment of the RLC SDU is first received at the RLC entity; and
generating the status PDU if the reassembly timer expires.

18. A transmitting device for transmitting a data unit in a wireless communication system, the transmitting device comprising:
a transceiver, and
a processor configured to control the transceiver, the processor configured to:
control the transceiver to receive a status PDU; and
control the transceiver to transmit a radio link control (RLC) service data unit (SDU) or RLC SDU segment indicated by the status PDU,
wherein the status PDU contains one sequence number (SN) for the multiple missing RLC SDU segments, which is the same as a SN of the RLC SDU, and location information on each of the multiple missing RLC SDU segments within the RLC SDU.

19. The transmitting device according to claim 18,
wherein the status PDU contains a first indicator (E1) field, a second indicator (E2) field and a third indicator (E3) field, and
wherein the E1 field indicates whether or not a SN (NACK_SN) for a missing RLC SDU or missing RLC SDU segment follows after the E3 field.

20. The transmitting device according to claim 19,
wherein, if the E1 field indicates that a NACK_SN does not follow after the E3 field, fields after the E3 field are associated with a latest SN before the E1 field.
